(19) United States
(12) Patent Application Publication
(10) Pub. No.: US 2005/0033690 A1
(43) Pub. Date: Feb. 10, 2005

(54) System and method for digital bill presentment and payment

(76) Inventors: Walter Gerard Antognini, New York, NY (US); Thomas Charles Antognini, Lexington, MA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/852,989

(22) Filed: May 25, 2004

Related U.S. Application Data
(63) Continuation of application No. 09/862,785, filed on May 18, 2001.
Application No. 09/862,785 is a continuation of application No. 08/977,510, filed on Nov. 24, 1997, now abandoned.
Application No. 08/977,510 is a continuation-in-part of application No. 08/609,549, filed on Mar. 1, 1996, now Pat. No. 6,098,882.

(51) Int. Cl. G06F 17/60

(52) U.S. Cl. 705/40

(57) ABSTRACT

A system of bill presentment and bill payment. The parties to the process, which typically include the bill presenter, bill payer, and bank, credit card company or other intermediary, select from a number of choices in the selection of information to include in the bill, preparation of the bill, acceptable payment methods, means to send the bill and bill payment instrument, means of signing the bill, bill payment instrument, receipt acknowledging deposit and payment, method of recording and reconciling payments, and further actions. An accumulation of choices by the involved parties can include digital information in each step that represents all of the significant data accumulated up to and including that step. That digital data preferably includes digital signatures of each party at each step so as to provide an audit trail in purely digital form. Where digital data is chosen for each step, the digital data can be electronic or, using machine readable code, printed on paper, regardless of the form chosen in prior or later steps.

This application is a continuation of application Ser. No. 08/977,510, filed Nov. 24, 1997, which is a continuation-in-part of application Ser. No. 08/609,549 filed Mar. 1, 1996, now U.S. Pat. No. 6,176,427.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

This invention relates to a system and method of presenting bills for payment and the payment of bills where the bill and/or the payment includes digital data representing the bill and/or the payment, preferably by using barcode to encode the digital data.

The traditional checking system typically involves the payer writing a check, recording that check, sending the check to the payee, the payee opening the envelope, endorsing the check, depositing the check in a bank account followed by the bank recording the check, settling with the payer's bank, sending the check to the payer's bank through the federal reserve system, with the payer's bank then sorting the checks by payer and sending those checks back to the payer with a checking statement. This system involves considerable effort by all parties—the payer, the payee, and the banks. Some or all of this process can be automated.

The American banking system processes an estimated 60 billion checks each year. If each payment consumes 5 to 10 minutes for the clerical functions of opening a bill, detaching the bill stub, writing a check, recording the check, inserting the bill stub and check in an envelope, sealing the envelope, addressing the envelope and applying postage, some 5 to 10 billion hours are consumed on clerical functions just by payers. Payees spend tens of billions of dollars to send out bills and then process incoming bill payments.

Methods have been devised to address the inefficiencies that arise from a purely human-readable paper system. But each of these methods have their disadvantages, primarily in the form of rigidity.

One method allows payers to use personal computer software to manage their personal finances. This software allows a user to choose between printing a check on the user's computer or to authorize the user's bank to send an electronic payment. One disadvantage to the user is the need to master personal computers in general and the software in particular. Also, for a user accustomed to receiving canceled checks, sending payments electronically leaves the payer with no proof of payment other than a notation on the monthly checking statement. Electronic payment has the further disadvantage of requiring a prearrangement with the payee to make electronic payment. The payee has the disadvantage of receiving a payment without the paperwork that traditionally accompanies the receipt of bill payments (e.g., a check with account number and customer indicated as well as the bill stub). Whatever information is sent by the bank with the electronic payment is information dictated by the bank and not the payee. Thus, matching payment with the proper payer and account can prove difficult and the payee must in any case adopt to a system outside its control in order to receive these payments.

If the payer alternatively chooses to have a personal computer issue a check, most of the advantages of using a computer are lost. While using a physical check has the advantages of the traditional payment method it requires the payer to feed checks into the printer, execute instructions to issue the check, remove the check from the printer, remove the bill stub from the bill, insert the check and bill stub into an envelope, seal the envelope, apply postage and mail the payment. The payer's and payee's banks and the banking system must still go through the costly and time consuming check clearing process.

A further method of bill payment involves automatic deduction of an amount due from the payer's checking account. This again requires prearrangement between the payer and payee. The payer must authorize the payee to go directly to the payer's bank with the authority to deduct the funds owing. While this method can have the advantage of eliminating all paperwork in the bill presentment and payment, it also has distinct disadvantages. Most bill payers feel uncomfortable giving a creditor authority to automatically go against the payer's checking account. This unease is especially true in those instances where the amount of the bill can vary widely. Most payers would object to losing control not only of the authority to pay bill pays but also the timing of the payment. As is true for most electronic payment methods, payers would normally have to wait until the next checking statement for even minimal physical evidence of payment. Payers would also feel uncomfortable in not receiving a physical, paper statement from the payee. While the payee can resolve this last issue by mailing a monthly statement, the process of mailing statements eliminates a major advantage of adopting a purely electronic approach—the cost and time savings of eliminating paper bills would no longer exist.

Other methods use variations of the above techniques.

U.S. Pat. No. 5,283,829, issued to Anderson, discloses an electronic bill payment system that includes an interactive payment approval apparatus into which subscribers dial to approve payment and which determines, based upon information collected, whether to initiate electronic funds transfer. To approve electronic bill payment a subscriber, once pre-authorized, dials up the payment approval apparatus and enters the assigned approval number. While the method obviates the need for the payer to issue a paper check, the method discloses a separate approval number for each bill to be paid, a separate telephone call for each bill, and the need to wait through a mechanical phone call in order to achieve the end result of paying the bill. The method requires a bill payer to authorize electronic funds transfer for each possible payee. Furthermore, the method discloses only one method of payment beyond traditional check writing and mailing, thus restricting the choices open to both bill payers and payees.

U.S. Pat. No. 5,652,786, issued to Rogers, discloses an automated interactive bill payment system. In the preferred embodiment, a caller calls a telepay system, enters an access code identifying the current payment transaction, enters the account number identifying the payee in connection with the current payment transaction, enters a debit card number, and enters a payment amount. The system provides for voice prompts instructing the user what information is called for. Like the other systems described, the system disclosed by Rogers provides a rigid method of payment as an alternative to traditional methods. The system also requires considerable input of information by punching telephone buttons, introducing possible errors and frustration.

Inefficiencies also exist in the context where the debtor determines the amount of liability. Tax return preparation represents a prime example of such a context. Tax relevant information typically undergoes multiple transformations from digital to paper and back. The circumstances of a typical employee illustrates this inefficiency. An employer typically uses a computer to account for wages earned by an employee. While employers sometimes use digital means to report wage information to the taxing authority (e.g., the Internal Revenue Service, “IRS”), the information reported to the employee is always on paper. This wage information which typically started out as digital information becomes transformed into human-readable information on paper. The employee then prepares his or her tax return. Most individual tax returns are prepared with the use of a computer, either by the individual or by a paid preparer. The preparer must manually input the human-readable information reported to the employee. The preparer typically prints out the tax return on paper. The employee sends this return to the taxing authority, which then manually inputs the tax return information into the taxing authority's computers.

### SUMMARY OF THE INVENTION

It is an object of the present invention to provide a system of bill presentment and bill payment that provides all parties a choice of as many bill presentment and payment methods as possible.

It is an object of the present invention to allow a system of bill presentment that is either on paper, typically delivered through the mails, or electronic, delivered by facsimile transmission, electronic mail, online access, or otherwise.

It is an object of the bill payment method of the present invention to provide a system of check writing that makes the essential information of the check available without the need to transfer the physical check by digitally encoding the essential information of the payment.

It is a further object of the method of bill payment to give the parties to the process a choice of whether, at any step of the process, to use paper to represent the check or to represent the check electronically.

It is an object of the invention to incorporate into the instrument of the bill payment method digital information derived from the bill presentment method. It is a further object of the invention to allow the bill presenter to determine what digital bill information comes back to the bill presenter from the bill payer regardless of how the bill is paid.

It is an object of the method of bill payment to allow the bill payer the option to pay multiple bills in one session and/or as part of one check.

It is an object of the method of bill presentment of the invention to allow the bill presenter to determine which of a plurality of bill payment methods the bill presenter can accommodate.

It is an object of the invention to provide an audit trail for each step of the bill presentment and payment process by requiring each party to the process to include their digital signature acknowledging the action they have taken.

It is an object of the invention to simplify the preparation and processing of tax returns by providing digital data to the taxpayer and/or the taxing authority.

It is an object of the present invention to provide a system of interacting with digital devices utilizing paper documents typically encoded with barcodes, reducing the complexity of interaction with digital devices so that the majority of consumers can employ these devices to conduct transactions, effect communication, and perform standalone functions.

It is an object of the present invention to allow simplified interaction with multifunction peripherals, digital copiers, and fax machines by encoding digital information on documents introduced into the devices, so that front panel operations, and retrieval of documents from the Internet, local networks, local disks, or via fax-back, can be performed with minimal input from the user.

It is an object of the present invention to allow simplified interaction with a variety of digital devices so that contact information relevant to each device can be encoded and extracted from a single pattern of machine readable information on a paper document.

It being an object of the invention to provide all parties to the bill presentment and payment process as much flexibility as practical in the methods used to transact the presentment and payment, the preferred embodiment of the invention provides at several points in the process a series of choices from which to select. In summary, the preferred embodiment starts with the bill presenter selecting which information to include in the bill, which methods of payment the bill presenter is prepared to accept, which method to use in sending the bill. The bill presenter then prepares and sends the bill based on the selections made. The bill payer, upon receipt of the bill, selects the method of preparing the bill payment, the method of bill payment, the method that the payer prefers for receiving back the bill paying instruments, the method of signing the instrument, the number of bills to pay at one time, the method of recording the bill payment and reconciling account balances, the method of sending the payment and the person to send the payment to. The bill payer then prepares and sends the payment according to the selections made. The method of processing the bill payment then varies based primarily on who receives the bill payment. If a credit card company or other intermediary receives the bill payment instrument, the person receiving the bill payment selects a method of sending payments instruments back to the bill payer and selects a method of paying the bill presenter. The credit card company then processes the bill payment and sends back the bill payment instruments on the basis of the selections made and settles up with the bill payer. If the bill presenters receives the bill payment, the bill presenter selects the method of endorsement and the method of deposit, endorsing and depositing the bill payment based on the selections made. If a bank is the person the bill payment is sent to or upon receipt of a deposit by the bill presenter, the bank selects a method of acknowledging payment, a method of sending back the bill payment instruments, a method of processing the payment, and a method settling up with the bill presenter and bill payer. The bank then processes the payment, settles up and sends acknowledgments and the bill payment instruments on the basis of the selections made. While some of these methods and selections are consistent with current practices or are otherwise known in the art, it is only with the invention that the wide variety of possibilities is made available.

The greatest advantages offered by the invention are achieved by including as part of each bill and as part of each bill payment instrument the digital information which represents the essential information of the bill and/or the bill payment instrument. It should be understood that other embodiments of the invention can convey at least some of the benefits being offered by the invention by using just some aspects of the invention. For example, if the bill contains digital information representing the bill information, that aspect of the invention alone could provide a benefit to the bill payer by virtue of allowing the bill payer to store the information as part of the payer's personal finance software application.

The following example illustrates one path a bill and corresponding payment can take pursuant to the invention. The bill and the instrument of bill payment (a check) each contain human readable and digital (machine readable) information on paper. Both human readable and digital information are printed on paper preferably by a computer printer, except for a handwritten signature. The digital information is printed on the bill and the check using a machine readable code, preferably a high density code such as that described in the pending Antognini et al. U.S. patent application that was filed Mar. 1, 1996, under Ser. No. 08/609,549 on “Variable Formatting of Digital Data Into a Pattern”. The digital information contained in the bill preferably includes, at a minimum, the name and location of the bill presenter, the name, address and account number of the debtor, the description of the goods or services for which payment is sought, including both the type and quantity of the goods or services and including any invoice or purchase order number or other reference, the amount owed, the terms for payment and due date of the payment. If the bill presenter chooses to include less information than what is preferred, the bill presenter should at least include in the digital data sufficient information from which the bill can be paid. This sufficient information normally includes identifying information of the bill payer (e.g., account name or number), identifying information of the bill presenter (typically the name) and the minimum amount due. In some cases, less (or more) information may be sufficient to pay the bill. The bill presenter decides what information is sufficient to pay the bill. The payer, using a scanner attached to a computer, scans the bill to recover its digital information and, using a printer attached to a computer, produces a check containing the digital information contained in the bill as well as the amount of payment made, the check number, the checking account number, the relevant bank information including name, address, and routing number, and the digital signature of the payer. The payer sends the check to the bill presenter through the mails. The bill presenter deposits the check in the bill presenter's bank. The bill presenter's bank scans the check, including the machine readable code This bank retains the physical check and electronically transmits to a clearing house the digital information contained on the check as well as the payer bank's digital verification that it has credited the amount of the check to the bill presenter's account. This digital verification is preferably accompanied by the digital signature of the bill presenter's bank. The clearing house then aggregates the electronic transmissions it receives, aggregating by payer bank, and transmits the aggregated information to each payer bank together with an indication that it has done so including the digital signature of the clearing house. The payer banks segregate the clearing house transmissions into the various payer accounts. On a regular basis, preferably no less than monthly, each payer bank sends to each payer (i.e., account holder) documentation that includes a checking account statement, a printout of the human readable information of each payment made, and a printout of the digital data that has accumulated for each payment made, including the verifications and digital signatures.

A method of tax return preparation and processing eliminates the two steps of manual input, both at the tax return preparation and the tax return processing stages. The method accomplishes this while retaining the use of paper both to report tax information and to prepare the return. The use of machine readable code on the printed paper provides the advantage of having paper which contains both human-readable and machine-readable information.

These and other objects of the invention will become apparent from a consideration of the drawings and ensuing description.

### BRIEF DESCRIPTION OF THE DRAWINGS

The present invention will be understood more fully from the detailed description given below and from the accompanying drawings of the preferred embodiments of the invention which, however, should not be taken to limit the invention to the specific embodiments, but are for explanation and understanding only.

FIG. 1 is a block diagram describing the overall method of bill presentment and bill payment according to the preferred embodiment.

FIG. 2 illustrates a bill with machine readable code containing bill information in digital form.

FIG. 3 illustrates a bill payment instrument containing bill payment information in digital form.

FIG. 4 is a block diagram illustrating the digital signatures applied to create a new paradigm for an audit trail.

FIG. 5 is a block diagram of a method of tax return preparation and processing that includes digital information at the various stages of the process.

FIG. 6 is a high level flowchart of a paper-based transaction system.

FIG. 7 is a block diagram of the process of automation of faxing or e-mailing of encoded paper documents.

FIG. 8A is an example data structure with contact information.

FIG. 8B illustrates example fields used by various digital devices.

### DETAILED DESCRIPTION OF THE PREFERRED EMBODIMENTS

For purposes of understanding this description it should be understood that a person preparing a bill to present to the person owing the bill is referred to at various times as the bill presenter, presenter, creditor or payee. The person owing the bill is referred to at various times as the bill payer, payer or debtor. A reference to an instrument or bill payment instrument should not be understood to refer exclusively to a physical instrument for bill payment but to instead include any indicia of bill payment whether physical, electronic or some combination thereof Where the description calls for use of a high density code, the symbology used in the preferred embodiment is that described in a copending Antognini et al. U.S. patent application that was filed Mar. 1, 1996, under Ser. No. 08/609,549 on “Variable Formatting of Digital Data Into a Pattern”.

This description makes numerous references to digital signatures. Digital signatures, as that term is meant for purposes of this discussion, does not (or need not) consist of a manual signature, digitized or otherwise. Digital signatures are a function of cryptography and are well known to those skilled in the art. The possibilities include, Digital Signature Algorithm (DSA), Rivest Shamir Adelman (RSA) Algorithm, and Elliptic Curve Digital Signature Algorithm (ECDSA). If appropriate protocols are followed, digital signatures provide a high degree of confidence that the bill payer and only the bill payer has affirmatively authorized payment. This high degree of confidence in authorization can extend to any items contained in the digital signature.

Some digital signature algorithms can be used for encryption of messages while other algorithms are designed to provide just a digital signature. Public key algorithms that can be used for encryption of messages operate by a person encrypting a message with that person's private key. That message can then be decrypted by anyone who has the complimentary public key. Because that public key is public, there should be no serious issue to making the key widely available. Assuming the appropriate protocols are followed, use of the private key provides strong (in theory, virtually irrefutable) evidence that the person owning that private key, and only that person, encrypted the message, thus providing the digital signature. The message can include any digital data, including the digital data described herein. Where the description of the invention makes reference to digital signatures that allow the signature to contain information, the reference should be understood as referring to application of these digital signature algorithms that allow encryption of messages and, in the process, provide a digital signature.

The parties to the process can choose the manner of making public keys available. One choice available is to provide the public key as part of the digital information provided with each instrument in the process. Another available choice is maintaining the key on a public key server.

### Bill Presentment and Payment System

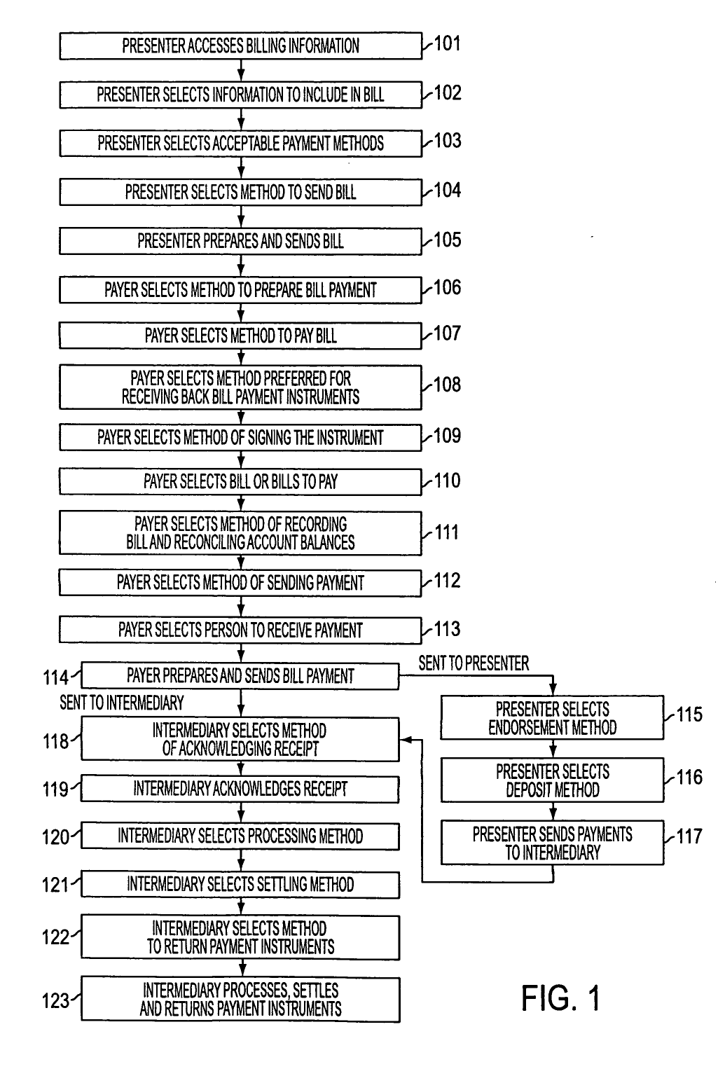

The operation of the overall method of presenting bills and paying those bills is described by reference to FIG. 1.

In the preferred embodiment, steps 101 through 105 and 115 through 117 are performed by the bill presenter by using a computer system with attached printer and fax/modem where that computer system includes a database of information about bill payers and bill production program and a user interface that allows the bill payer to make the choices and perform the actions outlined below. Likewise, in the preferred embodiment, steps 106 through 114 are performed by the bill payer through use of a computer system with attached printer and fax/modem with a bill payment program that allows the bill payer to make the choices available and perform the actions outlined below. Likewise, in the preferred embodiment, steps 118 through 123 are performed by the bank, credit card company or other intermediary through use of a computer system with attached printer and fax/modem with a bill payment instrument processing program software that allows the bank, credit card company or other intermediary to make the choices and perform the actions outlined below.

The process starts with decisions to be made by the bill presenter. The bill presenter prepares and sends a bill to the bill payer. This process starts with step 101, in which the bill production program accesses the information from the database traditionally accessed for each bill, usually including at a minimum: the minimum amount due for each debtor, the services or goods delivered including any invoice or purchase order number or other reference, the payment's due date, as well each debtor's name, address, and account number. The bill presenter may access other information relevant to the preparation of the bill, including for example, account balance (where different from the minimum due), and account activity for the last period.

In step 102, the bill presenter selects which of this information to include in the bill. The bill presenter inputs its selection in the bill production program. The decision of what information to include includes further decisions of what information to include in human readable form and what information to include in machine readable form. Including information in machine readable form assumes that the method of sending the bill in step 104 allows sending machine readable information. The presenter may choose to include in machine readable form all of the information discussed as part of the accessing of information step 101 as well as other information. For example, the presenter may choose to include computer instructions which instruct the bill payer's computer to update personal finance software, telephone the bill presenter's computer server such as for purposes of directing bill payment or bill payment information directly to the bill presenter, connect to an Internet site, provide promotional material, or any other steps that can be automated by computer instructions.

The digital data that the bill presenter includes in the bill can also include information intended for only the bill presenter and bill payer, not banks or other third parties. This digital data can be included by encrypting the data using an encryption key available only to the bill presenter and bill payer. This encryption process can be in accordance with any of several protocols known to those in the field of cryptography. This encryption might be appropriate for sensitive information such as charges for certain medical procedures, or charges for legal advice. Indeed, such a technique could enhance the protection afforded by the client/professional relationship.

The presenter can also choose to include a digital signature of the presenter, where that digital signature includes the other digital data provided in the bill. By providing a digital signature that includes the fundamental information of the bill, the bill presenter provides strong evidence that the bill presenter did indeed produce the bill and the details of that bill, should such issues ever arise. Because the proof is digital, the proof could be sent in electronic form rather than sending the physical document or photocopy thereof Governmental agencies may in particular consider a requirement that persons presenting bills to the government include a digital signature as an additional precaution against fraud and in order to expedite resolution of issues.

The method of the present invention allows possibilities beyond preparing the bill solely on the basis of accessed information.

In step 103, the bill presenter selects those methods of bill payment which the bill presenter is prepared to accept. The bill presenter inputs these selections in the bill production program. In the preferred embodiment the choices includes payment by traditional check or money order, currency, digital money, credit card, debit card, electronic funds transfer, direct credit, and the method of digital bill payment of the present invention. Traditional checks and money orders refer to the paper checks and money orders drawn on banks or the United States Postal Service or other intermediary, where the instrument is entirely or predominantly analog as opposed to digital (note that even traditional checks and money orders allow for some machine readable information—checks for example typically include account information printed in magnetic ink so that that information can be read by machines). Use of currency is certainly not a preferred method of payment in most circumstances. It may be considered acceptable, for example, where the payment is made in person. Digital money refers to methods of accounts reflecting transfers of resources and the resulting allocation of wealth of various persons that is entirely or primarily digital, primarily proffered currently for online commerce and offered as an alternative to traditional checking accounts and payment methods. While payment by credit card is relatively easy for the bill presenter to process, this method of payment presents the disadvantage of a charge imposed by the credit card company. This charge can be largely eliminated by using the debit card network. Electronic funds transfers can include wire transfers, Automated Clearing House transfers of the United States banking system, debit card network transfers or any other electronic transfer mechanism that is or will be in place. Direct credit refers to a system where a bank, credit card company or other intermediary maintains accounts with both bill presenter and bill payer or the bill presenter and bill payer have an open account with each other and the payment is an accounting entry made in the account or accounts. The method of bill payment of the present invention is through the digital bill payment instrument described later.

Further possibilities for the acceptable methods of payment in step 103 involve some form of automatic payment. In one such embodiment, the bill presenter and bill payer agree in advance that the amount due will be charged automatically against the bill payer's credit card, debit card, checking, postal meter, digital money or other account. In another embodiment, the bill payer's account is automatically charged unless the bill payer affirmatively objects to each such charge by a certain date. In a still further embodiment, the bill payer's account is automatically charged unless the bill payer provides an alternative form of payment by a certain date. In these instances where automatic payment is a possibility, the “bill” presented may serve not as a bill per se, but as a statement of charges made. The document presented, physical or electronic, may nonetheless include such digital information as is not inconsistent with the fact that the amount may be paid automatically. For example, the document may include digital information indicating the payee, amount, account charged, date charged and services or goods rendered including any invoice or purchase order number or other reference, but should not indicate other acceptable methods of payment where the amount has already been or will be automatically charged in all cases. Digital information on the payee, amount, account charged, date charged, and services or goods rendered including any invoice or purchase order number or other reference can assist the payer's computerized recordkeeping. There should be no need, however, for indicating other acceptable methods of payment if payment has already been made.

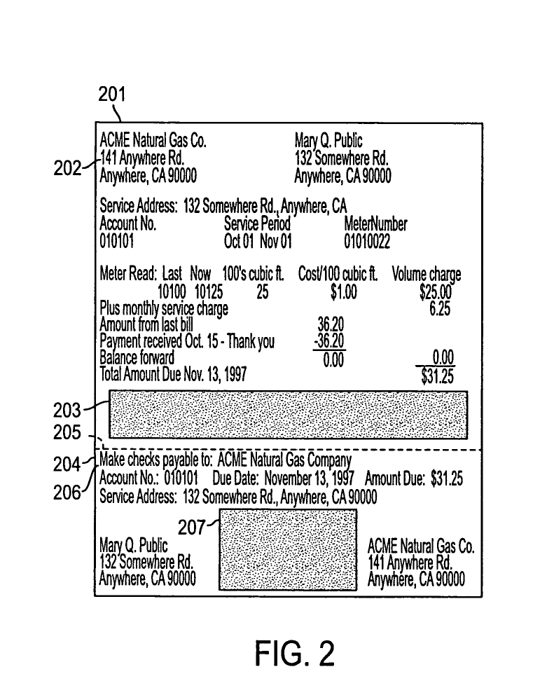

In step 104 the bill presenter selects a method for sending the bill to the debtor. The bill presenter inputs the selection into the bill production program. The choices include printing a bill with human readable information but without machine readable data, printing a bill with both human readable and machine readable information, electronic mail notice only, electronic mail with an attachment that contains digital information either in the form of an image of machine readable code that contains digital information or otherwise in electronic form, electronic mail that directly integrates digital information or an image of machine readable code containing digital information, and facsimile transmission of human readable and/or an image of machine readable information. As discussed herein, a reference to human readable information includes text or graphics included as part of electronic mail or a facsimile transmission. The first possibility is the traditional bill, printed on paper, with only human readable information, largely or entirely text. The second possibility involves printing the bill with human readable and machine readable information. The machine readable information is preferably printed with a high-density code. An example of a bill pursuant to this second possibility is as illustrated in FIG. 2. The third possibility is the use of electronic mail (e-mail) to send notice of the bill. The bill presenter may choose to deliver the electronic mail through the Internet, an intranet, an extranet, LAN, WAN, electronic bulletin board or other electronic network. The fourth possibility attaches to the human readable electronic mail a file that contains bill information in digital form so that if so desired the digital information can be further processed by the bill payer's computer. This attached file can be a file of the digital data itself or, preferably, a file containing an image of a high density code that represents the digital data. If standards are developed and widely employed that allow facsimile transmissions through the Internet, the image of the high density code (as well human readable information if desired) could be based on facsimile protocols. The fifth possibility integrates the digital data directly into the electronic mail without the need to resort to an attachment. If, for example, an electronic mail system allows messages that can include both text and graphics, the bill presenter may choose to send electronic mail messages that include both human readable information and an image of a high density code that represents digital data. In this example, the bill payer can choose to print the entire message on paper for scanning and/or physical archiving or decode it directly from the electronic image by the bill payer's computer. The sixth possibility involves sending the bill through facsimile transmission. The bill transmitted (i.e., the image of the bill) can include just human readable information or human readable information together with machine readable information. The machine readable information preferably utilizes a high density code.

In further embodiments step 104 would include as choices bills that include machine readable information only. While such embodiments are not normally preferred, there may be instances where there is no need for human intervention in the bill presentment and payment process. For example, a system may be established where if a bill's indication of amounts due and descriptions of goods or services rendered, including any invoice or purchase order number or other reference, corresponds with the bill payer's electronic records then the bill will be paid automatically without need for a human to read any information from the bill. In this instance, only the digital data need be included on the bill. The electronic payment process would establish a trail of actions taken and, if need be, would thereby allow a human to read at some later time a description of the actions taken. The bill could be printed on paper, sent by electronic mail or transmitted by facsimile, as otherwise discussed above.

The choices as to acceptable payment methods and methods for sending bills may be made for all debtors or for particular debtors. The bill production program stores presenter's choices and associates these choices with particular payers or groups of payers.

In step 105, the bill presenter prepares and send the bill. The bill is prepared and sent consistent with the choices made in steps 102, 103 and 104. The bill contains the information selected in step 102 and indicates the acceptable methods of payment selected in step 103. The information selected and the acceptable methods selected are placed in human readable and/or machine readable form depending on the choices made by the bill presenter. The bill is preferably prepared entirely by computer. The presenter sends the bill by electronic transmission where so selected, by the mails or other delivery where printed or by facsimile transmission where so selected. If the bill presenter chooses to send a bill by facsimile transmission, the bill presenter can print and then manually feed the bill through a fax machine, or the bill presenter may choose to send the bill directly from the bill presenter's fax modem or, as discussed above, as an attachment to electronic mail where the attachment consists of a file consistent with facsimile protocols. The bill sent by facsimile transmission can likewise be received by the bill payer in a number of different ways including by fax machine, by fax/modem and as an attachment to electronic mail.

In other embodiments the bill is prepared partially or entirely by hand. In one such other embodiment, the bill consists of a preprinted form with handwritten entries and machine readable information either preprinted or added by a stamp, manual or machine generated.

The bill payer, having received the bill from the bill presenter, is given a number of selections relating to the payment of the bill. It should be noted that many of these selections involve choices also available to the bill presenter. In some cases, the selection which the bill presenter makes or would make is inconsistent with the selection which the bill payer makes or would make. While the preferred embodiment is intended to give as much flexibility as possible to all parties, some choices may be inconsistent. For example, in selecting the methods of acceptable bill payment the bill presenter may purposely omit payment by credit card while the bill payer may select to pay by credit card. These conflicts should ultimately be resolved based on the terms of the contract between the bill presenter and bill payer. In the preferred embodiment, the choice made by the last person to act on any such choice determines how the process is completed provided that such last person is put on notice that such choice is inconsistent with a prior selection made by another party. Returning to the prior example, if the bill payer selects payment by credit card notwithstanding having been put on notice that credit card payment is not acceptable to the bill presenter, the invention proceeds with the payment by credit card. It is then up to the bill presenter to either accept or reject the tendered payment.

In step 106, the payer selects a method of preparing the bill payment. This selection refers to how the payer mechanically proceeds. There are at least five possible choices: manual preparation of the bill payment, use of a general purpose computer, use of third party computerized equipment, use of a stand alone device that has some ability to execute logical instructions and use of a telephone.

In manual preparation, the bill payer uses the traditional manual check writing and recording, generally followed by inserting the bill and check into an envelope, sealing the envelope, applying postage, and mailing the envelope. The invention nonetheless offers the advantage of allowing the bill payer to archive the bill which contains digital data. The bill payer can later access that digital data—e.g. to import the digital data into a personal finance software application or to just store the data on the bill payer's computer for reference. If the bill was received on paper and the bill payer chooses manual preparation, the bill payer would have to scan and decode the digital data in order to input into the bill payer's computer.

The use of a general use computer, typically a personal computer for individuals and small businesses, offers the most flexibility in how digital data gets used. The manner of inputting the digital data and making it available for use depends on the manner in which the digital data is received. If the digital data is received on paper in the form of machine readable code, the bill payer, using a scanner attached to the computer, scans and decodes the digital data. If the bill payer's computer already contains the digital data, as might be the case where the digital data is provided through electronic mail or as an attachment to electronic mail, no further steps need be taken to make the digital data available in electronic format. If the bill payer's computer contains an image of the digital data, the image must be decoded to produce the digital data in electronic format for further use. Any decoding is preferably performed automatically, called into action by the scanning process, the process of opening the e-mail, or the process of opening the facsimile image, as the case may be. Use of a computer allows the bill payer to process bill payment by taking advantage of a myriad of choices available, as described in further steps of the invention. The computer used by a large organization might be larger than a personal computer and might use scanners capable of producing dozens of scans per hour.

The third possibility in the selection of the method of preparation is to use the computerized equipment of a third party. Use of a third party's computerized equipment allows a user to take advantage of many aspects of the invention without the need to invest in or need to learn use of a computer and other equipment (e.g., a scanner and fax/modem). Third party computerized equipment in current use could be modified to better accommodate the method of bill presentment and payment. More particularly, automated teller machines (“ATM”s) maintained by banks or other entities or kiosks could be equipped with scanners so that that equipment could scan and decode the digital data printed on bills. Thus, for example, a person receiving a series of bill containing digital data takes those bills to an ATM. After inserting a banking card and entering a PIN, consistent with current ATM protocols, a bill payer is presented with a number of choices, one of which is payment of bills. After selecting this option, the bill payer is instructed to feed the bill into the ATM's scanner, much as deposits are currently fed into ATMs now. The ATM then scans and decode the digitized bill. The ATM then asks how the bill payer wants to pay the bill, the choices including a checking or other bank account, a credit card, a debit card (including the debit card used to initiate the transaction), checks or money orders, digital or otherwise, digital prepayments (such as those discussed further below in the context of self-certifying bill payment instruments) or some other form of payment. Preferably after asking the bill payer to confirm payment of the bill, the ATM then processes the transaction, pays the bill presenter through electronic funds transfers or other methods of payment acceptable to the maintainer (e.g., the owner of the ATM, such as a bank). The ATM preferably allows payment of more than one bill at the same session. And, of course, the bill payer could also withdraw cash or proceed with some other traditional ATM transaction as part of the same ATM visit, thus allowing the bill payer to pay bills without making a special trip to the ATM.

The bill payment would preferably be in a form acceptable to the bill presenter. Use of a method not acceptable to the bill presenter may contravene not only contractual restrictions but also that which is feasible. For example, the bill presenter may not provide electronic funds payment as a choice. If the maintainer of the ATM only allows payment by electronic funds transfer, the ATM maintainer may not have sufficient information (such as bill presenter bank and account information) to make the bill payment. Thus, unless the ATM maintainer has some alternative method of making payment, the payment cannot be made. One possible alternative is a backup system where the ATM initiates a process where a physical check is issued and sent to the bill presenter, through the mail or otherwise.

Upon completion of the bill payments, the ATM preferably issues a receipt to the bill payer. This receipt could itself take a number of different forms. The receipt should at a minimum contain human readable information indicating the ATM maintainer's name and ATM address, the payer's name and time, place, amount, form and recipient of the payment. The receipt could also include as human readable information the bill payer's account number as well as some indication of what the payment is for—e.g., if the bill is for utility services, the bill could disclose the period of coverage. The ATM determines and discloses the information from the digital data on the bill stub inserted into and scanned by the ATM.

The receipt preferably discloses digital information. The digital information consists of the bank's digital signature which includes all of the digital information accumulated to that point.

The fourth choice for method of preparing a bill payment is use of a stand alone device that has some ability to execute logical instructions. Use of this type of equipment allows the bill payer to pay with some of the automation afforded by the invention while using equipment that is relatively simple to use—the complications sometimes associated with computers are largely avoided. Facsimile machines are one example of equipment in this category. The OBOS™ One Button Ordering System by OBOS, Inc. of Wilmington, Del. is another such type of equipment. The OBOS device allows a user to insert a piece of paper, press a button, and the device will scan the paper, place a telephone call to a number preprogrammed into the device, and transmit an image of the scanned paper to a fax server at the other end of the telephone number. The bill payer could likewise choose a facsimile machine by placing a paper payment instrument into the facsimile machine and manually entering a telephone number, or pressing a button that recalls a telephone number, causing the facsimile machine to call the number, scan the paper and transmit an image of the scanned paper. With either the OBOS system or a facsimile machine, a fax server preferably receives the scanned image and decodes the digital information contained on that image to process the bill payment.

Other devices could be used that have a similar effect. For example, a device similar to the OBOS device modified to allow an arbitrary telephone number to be called based on information printed (in human or machine readable form) on a bill could be used to transmit information to any fax server not just a preprogrammed fax server.

Whichever device is used the scanned image includes at least the bill. If the bill presenter has information on what account or other payment method to charge, transmission of the bill back to the bill presenter may be sufficient to effect payment. If the bill contains digital information on the bill payer's bank account (as accomplished by prearrangement with the bill payer) transmission of the bill by the bill payer to the bill payer's bank should provide sufficient information for the bank to process the payment. In other possibilities the bill payer is required to provide information in addition to the bill itself The bill payer may choose to provide such additional information, principally the account type and number, by preprogramming that information into the transmission device, by providing the information in human readable or machine readable format on a second piece of paper, or stamped or otherwise applied (as with a label) onto the bill using human readable or machine readable information. The paper, one or more pieces, is then transmitted to the fax server to be decoded and processed.

The fifth method for preparing bill payment is by telephone. This method could include calling the bill presenter to authorize use of the bill payer's credit or debit card or electronic funds transfer. The method also encompasses the methods disclosed in U.S. Pat. No. 5,283,829, issued to Anderson and U.S. Pat. No. 5,652,786, issued to Rogers.

In those instances where the bill payer uses a computer system (either of the bill payer or a third party), the bill payment program derives any digital data from the bill. The bill payment program then uses that digital data to inform the bill payer which methods of bill payment are acceptable to the bill presenter, and to prepare the digital data contained in the bill payment instrument. In the preferred embodiment, the bill payment program creates digital data for the bill payment instrument by concatenating the bill's digital data with the digital data that constitutes the bill payment instrument. In the preferred embodiment, the bill payment program can pay an amount different from that provided in the bill by allowing the bill payer the choice to overide the bill payment amount.

In step 107, the bill payer selects the method to pay the bill. The bill payer preferably has at least the following choices: credit card, debit card, check, money order, electronic funds transfer, direct credit, digital bill payment instruments, digital money, and automatic payment. A further possibility is the payment of cash, typically by direct delivery between the bill presenter and bill payer These choices are as discussed as part of the bill presenter's selection of choices of acceptable methods of bill payment, step 103. As previously discussed, while the preferred embodiment resolves any mechanical conflict in the bill payment method deemed acceptable by the bill presenter and the payment method chosen by the bill payer in favor of the bill payer, this issue should be resolved beforehand by agreement of the parties.

Digital bill payment instruments are the preferred possibility which the bill payer prepares by using a computer system and a bill payment program. The instruments contain digital data that preferably includes, at a minimum, the bill presenter's name, address, and account number between bill presenter and bill payer, the amount being paid, the due date of the bill, the goods and services rendered together with any purchase order or invoice reference and any other information included in digital form (if any) on the bill. If less than the preferred minimal information is placed in digital form, the bill payment program should at least include in the digital data sufficient information to pay the bill. The information sufficient to make the payment would normally include the name of the payee and payer, and the amount and date of the payment and account number from which payment is made. Of course, in some circumstances, the parties may determine that more or less information is sufficient to make payment.

In step 108, the bill payer selects the method for receiving back the bill payment instruments. The choices preferably include at a minimum, receiving the physical bill payment instruments, human readable images of the bill payment instruments, digital representations of the bill payment instruments, a listing of payments made, and digital representations of the bill payment instruments together with the bill payment instruments or human readable images of the bill payment instruments or a listing of payments made. This step involves, conceptually, the same selection of choices that the bank or other intermediary has in determining the method of returning the bill payment instruments, steps 124 and 115, respectively. The preferred embodiment allows both the bill payer and the bank or other intermediary to make their choice of method. A conflict in the choices made must somehow be resolved. The conflict is best resolved beforehand by agreement of the parties. If there is no such agreement and a conflict arises, the preferred embodiment resolves the conflict by proceeding with the selection made by the last person to choose—the bank or other intermediary. It is then left with the bill payer and the bank or other intermediary to contractually resolve further conflicts.

The first possibility, receiving the physical bill payment instruments, is consistent with current banking practices of returning canceled checks together with a monthly checking account statement. This practice could be continued by banks or other intermediaries in the case where a bank is not involved.

The second possibility is receiving images of the bill payment instruments. This is consistent with a growing practice of banks, and the practice sometimes used by credit card companies, of providing laser printed images of checks or receipts with a monthly statement. The human readable images could also be transmitted by facsimile or other electronic transmission.

The third possibility is receiving just a digital representation of the bill payment instruments. The digital representation could be received as an image of machine readable data on paper, an image of machine readable data transmitted by facsimile or other electronic transmission, or direct electronic transmission. In the case of an image on paper or by facsimile or other electronic transmission, the machine readable code is preferably a high density code. Receiving just a digital representation offers the possibility of greatest cost savings. It may also offer the advantage of easier integration into the bill payer's accounting system. If the bill payer intends in all cases to enter the information into a computerized accounting system (e.g., a COBOL based system of a large organization or the personal finance software application found on the personal computers of many individuals), receiving just the digital representation may be advantageous.

The digital representations preferably include both bill payment data and files containing images of the bill payment instruments. As used in the context of this step 108, the difference intended between human readable images received in a facsimile or other electronic transmissions and digital representations that include files containing images is the format and intended use of the electronic transmission. While both possibilities are, technically, digital, what is intended for digital representations that include image files is that the images will not be automatically presented to the bill payer upon receipt. In the case of facsimile or electronic mail transmissions of human readable information, the bill payer will by default see images of the bill payment instruments. This somewhat semantical distinction should in no way be construed to limit the choices offered by the invention.

The fourth possibility is a listing of the payments made. This listing preferably includes all the relevant information of the payment including the payee, date of payment, amount of payment, goods or services rendered, any invoice or purchase order number or other reference, and the bill payer's account number with the payee. Providing only a listing of the payments made is consistent with the current practices of many credit card companies.

The fifth possibility involves receiving digital representations of the bill payment instruments together with the bill payment instruments and/or images of the bill payment instruments and/or a listing of the payments made. This possibility basically represents some combination of the previously discussed possibilities. The combination can come together in the same media (e.g., both human readable images and digital representations on paper) or in separate media, such as human readable images on paper together with electronic transmission of digital representations of the bill payment instruments. The redundancy in information—both human readable and machine readable—serves important purposes. The purpose of human readable information is self-evident—to allow the bill payer to view the information. The purpose of the machine readable information is to allow the bill payer to both archive the information and use the information for further analysis, such as importing into personal finance software program.

The return of bill payment instruments preferably occurs at least monthly.

In step 109, the bill payer next selects a method of signing the bill payment instrument. The choices preferably include at a minimum: no signature, manual signature, stamped signature, computer printed signatures, digitized manual signature and digital signature. Manual signatures, stamped signatures, and computer printed signatures are consistent with current practices. Likewise, providing no signature is an apparently increasing practice, based partially on the trust that the paying party will honor the commitment without need for written authorization—e.g., the ordering of goods or the payment of debt by credit card over the telephone.

Digitized manual signatures can be provided in at least 2 ways. The first possibility involves scanning a manual signature (i.e., ink on paper). The second involves capturing a manual signature on a digitizing tablet, as a bitmap image, a vector image or in some other form. The result in either instance is a file that represents the manual signature which can then appended to the bill payment instrument. The bill payer chooses one of these 2 ways to provide a digitized manual signature. The method of appending depends on the form of the instrument. A paper instrument contains the digitized manual signature in machine readable code, preferably a high density code. An electronic instrument contains the digitized manual signature as an image of a high density code containing the digitized manual signature or directly in electronic form.

A digital signature preferably contains the amount and date of payment, the payee, the bill payer's account number with the bill presenter, the checking or other financial account number, the financial organization the funds are drawn on, the reason for the payment and other information pertinent to the payment. The digital signature can also contain a digitized manual signature. The digitized signature is digital data which is added to the bill payment instrument in a manner consistent with the manner of adding other digital data discussed above.

Of course, it should be understood that the bill payer can choose some combination of the above signature possibilities. For example, the payer can choose to include both a manual signature and a purely digital signature to good effect. This combination provides consistency with current practices while also providing the advantages of digital signatures.

In step 110, the bill payer selects which bill or bills to pay. The convenience offered to the bill payer by the invention is generally increased by processing a plurality of bills in the same sitting. The manner of processing multiple payments can then vary.

If the bill payer chooses to pay by ATM, the bill payer inserts more than one bill into the ATM scanner. The ATM could ask for confirmation for each bill or for all bills together.

If a bill payment instrument is printed, the bill payer chooses the number of payments to include in that instrument. If the bill payer sends the check to the bill payer's bank or other intermediary, one instrument for all payments minimizes efforts for both the bill payer and the bank, and should pose no inconvenience to the bill presenter provided the bill presenter can accept some form of payment other than a physical check. If a physical check is required, the bank or other intermediary prints and send a check such bill presenter, consistent with the information provided by the bill presenter on the bill.

Payment of multiple bills on one instrument sent to one of the bill presenters is possible although not generally preferred. This one instrument sent to one of the bill presenters, where used, preferably contains the payments to the other payees only in digital format. Furthermore, the digital information contained in these other payments is preferably encrypted so as to keep private the information contained therein. Encryption would be done through one of the well-known algorithms that makes a key available to the bill payer and the bank, credit card company or other intermediary. The recipient bill presenter would then deposit this instrument with the recipient bill presenter's bank. That bank would decrypt the entire instrument using the key. The result of the decoding would be a series of bill payments which the bank would process in the fashion described below.

The bill payer selects in step 111 the method for recording bill payments and reconciling checking and other account balances. The primary possibilities are manual, manual input into a computer and manual reconciliation, and automatic or largely automatic recording and reconciliation.

The manual possibility is a reference to the traditional method of manually recording payments into a check register, manually entering a running total, and then manually reconciling those totals with monthly checking statements. The manual method also encompasses the common practice of quickly reviewing credit card statements for correctness, it being understood that no manual entry is actually made or that such statements may not be reviewed for correctness at all.

The second possibility is consistent with the current practice of using accounting software for the entry and reconciliation of bill payments. This possibility encompasses sophisticated COBOL or other language systems employed by large organizations as well as personal finance software applications employed on personal computers. If checks are written by the system, recording is usually automatic. Otherwise, the payments are manually input. Personal finance software typically requires a large degree of manual effort to reconcile the physical checking or other account with the computer account balance.

The third possibility is an automatic or largely automatic recording and reconciling method. This method preferably issues bill payment instruments by computer. This computerized issuance can be by attached printer, facsimile or other electronic transmission. By virtue of being generated by computer, the bill payments are accessible by the computer, thus obviating the need for manual input. The bill payment instruments preferably contain a digital signature of the bill payer so as to increase the confidence that the payments reported by the payer's bank or other intermediary are correct and recorded. When the bill payment instruments are received back, at least one method for such return is digital. At least one form for the bank statement is also preferably digital, and preferably as part of the same transmission (whether on paper or electronic) as the bill payment instruments. By receiving the instruments and statement back in digital form the bill payer can place this digital data in the payer's accounting software application by, as the case may be, decoding or scanning and decoding an image of the digital data or, if the digital data is sent back in purely electronic form (i.e., not an image) by just importing the data to the accounting software application.

Accounting software can be adapted to automatically reconcile the information and balance present before receipt of the statement with information in the statement. To the extent that items match up, the previous information reconciles with the statement. The accounting software application would preferably highlight any discrepancies for manual examination by the bill payer. For example, the software application might indicate that the balances and information reconcile except for the following: certain bill payment instruments are still outstanding, certain cash withdrawals from ATMs were made and not input into the accounting software application, and certain bill payment instruments were hand written and not input into the accounting software application. The bill payer might quickly recognize the legitimacy of all these discrepancies and click an “OK” button in the software application, the effect of which is to continue to treat outstanding checks as outstanding (i.e., take no action), and input the cash withdrawals and manually prepared checks into the software application.

In step 112, the payer selects the method for sending the bill payments. These choices are largely consistent with the bill presenter's choices for sending bills (step 104): printing a bill payment instrument with human readable information but without machine readable data, printing a bill payment instrument with both human readable and machine readable information, electronic mail notice only, electronic mail with an attachment that contains digital information either in the form of an image of machine readable code that contains digital information or otherwise in electronic form, electronic mail that directly integrates digital information or an image of machine readable code containing digital information, and facsimile transmission of human readable and/or an image of machine readable information. The bill payer has the further option of using an automated teller machine or other third party computerized equipment to transmit bill payment.

In step 113, the bill payer selects the person to receive the payment. The choices include the bill presenter, the bill payer's bank, the bill presenter's bank, or some other intermediary. It should be understood that the choice in this step 113 can be restricted by choices made in other steps. For example, if the bill payer has chosen to pay by using a bank automated teller machine, the choice of bill recipient is the bill payer's bank or some other ATM maintainer. Further restrictions in choices would be obvious to those skilled in the field.

In step 114, the bill payer prepares and sends the bill payment or payments. The bill payment or payments are prepared and sent in accordance with the choices made in the prior steps. The details of bill payment preparation and transmission are largely consistent with bill preparation and transmission discussed by reference to step 105, with differences obvious to those skilled in the art.

When preparing the bill payment instrument, the bill payer may choose to include supplementary information, either in digital or human readable form. The bill payer may wish to make this information part of the bill payment instrument. If the supplementary information is sensitive, the bill payer may wish encrypt it first.

The process following transmission of the bill payment or payments by the payer varies according to which person receives the bill payment or payments. The persons who may receive any such payment fall into 2 categories for this purpose: the bill presenters or banks, credit card companies or other intermediaries. Accordingly, the process can follow 2 different tracks.

The first track for processing the bill payment sent by the payer becomes relevant when the bill payer sends the bill payment directly to the bill presenter. The invention offers the bill presenter further options.

In step 115, the bill presenter selects a method of endorsing the bill payment instruments. The choices preferably include a handwritten signature, a human readable stamp, a digital stamp, a picture of the person cashing or depositing the bill payment instrument, some combination of the above or none of the above.

Handwritten signatures and human readable stamps are the traditional methods of endorsing checks. These possibilities are often accompanied by an indication of the account number for deposit as well as a restriction such as “for deposit only”. Stamps can be provided by machine, or rubber stamp.

A digital stamp is the preferable choice. A digital stamp consists of digital data where that digital data preferably includes a digital signature of the bill presenter where that digital signature preferably includes an accumulation of the digital data from prior steps of the bill presentment and payment process. That accumulation preferably includes at a minimum, the name of the bill presenter, bill payer, date the bill was prepared, amount of the bill, a description of the goods or services rendered including any invoice or purchase order number or other reference, the amount of payment, the bill payer's account number with the bill presenter, the bill payer's bank or other intermediary account number, the digital signature of the bill payer, the date of payment, the date of the bill presenter's endorsement, the bill presenter's deposit account number (including the number of the bank of deposit), the date of deposit and a reference to any deposit slip number or other unique identifier of the deposit if one exists. Producing a digital signature in this step 115 follows the description of the bill payer producing a digital signature as described in step 109, except for the data included in that digital signature and, of course, the use of the bill presenter's encryption key rather than the bill payer's encryption key.

Use of a digital signature that includes the accumulation of digital data provides significant evidence that the bill presenter received payment, the amount of payment received and the reason for the payment. This digital signature is another component of the new paradigm for an audit trail established by the invention.

Producing a digital signature containing the unique details of a particular transaction requires a mechanism that can produce such unique digital signature and then apply or attach that digital signature to the bill payment instrument. Such device must be computerized (i.e., capable of executing the logical instructions needed to produce and apply the digital signature) or attached to a computer.

In some embodiments, a digital signature includes only static information, omitting details of the particular bill or bill payment. This possibility is especially relevant where the bill presenter's payment deposit process does not allow for producing or applying a distinct endorsement for each bill payment instrument Thus, where the bill presenter simply applies a stamp imprint (i.e., as produced by a rubber stamp or other device that does not vary the imprint) to the back of checks, every imprint made contains the same information. While the information can not vary, the information could include a digital signature by using a high density code to produce the rubber stamp or other such stamping device. While the possibility of applying a static stamp impression is particularly relevant to bill payment endorsement, it of course should be understood that the possibility of applying a static digital signature can occur for any digital signature in the bill presentment and payment process.

An endorsement that includes an image of the payee provides proof of who received payment. This possibility might be particularly useful in the context of governmental checks sent to individuals, such as social security, welfare, and tax refund checks. Including such images could significantly reduce the incidence of fraud and, where fraud does occur, assist in the apprehension of the perpetrators. The image captured at the time of cashing or depositing could be printed on the bill payment instrument in human readable form and/or preferably included in digital form.

In further embodiments, the image of the payee is, instead of or in addition to the payee's face, an image of that person's fingerprint, palmprint, or a voice print, heat signature, digital motor control or any other unique identifying characteristics. The possibility of including an image of a person's face or other identifying characteristics can also apply to any other aspect of the invention that calls for a signature, such as the bill payer signing the bill payment instrument.

The payee may choose an endorsement method that includes some combination of the choices described. For example, a stamped endorsement might include both a digital signature and a manual signature. The manual signature would be consistent with traditional practices and processes while the digital signature provides the advantages of the new paradigm for an audit trail.

There are some circumstances where no endorsement is required. Even with present practices, checks can slip through the clearing process without an endorsement. In the case of a direct credit, there may be no provision for endorsement. For payments made by telephone there is no endorsement of the payment. Payments made by electronic funds transfers or through debit card networks or credit cards may not require endorsement, or endorsement may be made to a batch of payments rather than individually.

Payments received by the bill presenter are generally processed through third parties, typically banks or credit card companies. In step 116, the bill presenter selects a method for depositing the payments received. The term “deposit” as used in this context should be understood to include any presentment of the payments to the third party for the purpose of having that third party process those payments so that the resources represented by those payments are ultimately made available to the bill presenter. The available choices preferably include at a minimum, deposit of the physical instruments, cashing the physical instrument, imaging any physical instruments and electronically transmitting the digital data, and imaging any physical instruments and depositing a physical digital deposit slip. It should be understood that while many of these choices involve processing physical instruments, the instruments need not have always been physical. The invention offers the advantage of digital instruments that as digital, can be transformed from physical to electronic or vice versa, in any combination and any number of times. For example, a bill payer may choose to transmit by fax a digital bill payment instrument to a bill presenter. The bill presenter might then physically deposit the paper containing the bill payment instrument (the instrument itself contains the digital data in machine readable code). The bank might then convert that paper bill payment instrument back to electronic form for processing and then convert the electronic form back to paper for purposes of sending to the bill payer as part of the bill payer's monthly checking account statement.

Deposit of physical instruments represents the traditional method of making deposits. This process usually includes use of an accompanying deposit slip. Enhancements of the traditional include the appending of a picture of the depositor, described above.

Cashing of the physical bill payment instruments also represents a traditional practice. As is true with the physical deposit choice, appending a picture of the person cashing the instrument to the instrument is an option.

The bill presenter might choose to image any physical bill instruments and then make an electronic deposit of bill payment instruments. The presenter may choose to include in an electronic deposit those instruments that have been imaged as well as bill payment instruments that came to the bill presenter in electronic form. The bill presenter images the physical bill instruments by exposing the instruments to a scanning device, such as a dedicated scanner, a digital camera, or a fax machine. The bill payment instruments imaged are preferably those that contain digital data in machine readable form. The instruments can also contain human readable information but the information used for further processing is preferably in digital form so as to introduce the advantages of machine readable code over optical character recognition (OCR), intelligent character recognition (ICR) and other such technologies that attempt to convert human readable information into electronic form. The advantages offered by machine readable code include greater accuracy in converting images to electronic form, as well as the use of error detection and error correction protocols. In one embodiment, notwithstanding the advantages of machine readable code, the bill presenter can choose to image a purely human readable instrument and rely on the OCR and/or ICR technologies for conversion.

A digital deposit, whether in electronic form as discussed above, or as part of a physical deposit slip discussed below, preferably includes digital data that represents basic deposit information. The basic deposit information includes a listing of the amount of each check, the total deposit, the account for deposit, and the date of deposit. The digital deposit preferably also contains the bill presenter's digital signature that contains all of the information that constitutes the deposit. The information that constitutes the deposit preferably includes all the information accumulated up to this point including all prior digital signatures. Thus, the deposit preferably includes in digital form all the information included on each bill, all of the information included in each payment as well as the information unique to the deposit. This digital signature of the bill presenter presents strong evidence that the bill presenter received and intended to make a deposit of all the payments that are part of that deposit. If the bank or other intermediary accepts the deposit, the bill presenter will have difficulty disproving the deposit of each item included in the deposit, including the wealth of information included with each item such as what amount was paid for what goods or service rendered. The inability to disprove receipt and deposit of each item included in the deposit represents a further component of the new paradigm of an audit trail and provides the bill presenter the advantage of increased internal controls.

The choice of imaging any physical bill payment instruments followed by producing and depositing a digital deposit slip commences with the same processes as the imaging and electronic transmission choice discussed above. The bill presenter images the physical instruments and accumulates those images with any bill payments that came to the bill presenter in electronic form. The bill presenter adds to the data representing the accumulated payments the deposit information. The accumulated digital data is then converted into machine readable code and printed on paper. That paper is then physically deposited.

As one choice, the bill presenter produces an image of the accumulated digital data and transmits that image to the bank or other intermediary by facsimile transmission. The presenter can choose to first print the image on paper and then send by fax machine or other comparable stand alone device, or produce and process the image in an entirely electronic form, transmitting the image by fax/modem.

In step 117, the bill payer prepares and sends the bill payment instrument or instruments to the bank, credit card company or other intermediary for further processing. The preparation and transmission is done consistent with the choices made by the bill presenter.

Upon receipt of the deposit of the bill payments from the bill presenter or directly from the payer, the bank, credit card company or other intermediary processes the bill payment instrument or instruments.

In step 118, the bank, credit card company or other intermediary selects a method for acknowledging receipt. The choices preferably include at a minimum, a stamped receipt, a digital receipt, acknowledgment as part of a periodic statement, some combination of the above, or no receipt.

Stamped receipts are consistent with traditional practices. Banks may manually stamp the deposit receipt with a time and date stamp that also includes the bank name and branch. Banks may also issue a printed receipt automatically when the deposit is made into an ATM or other device that accepts deposits.

A digital receipt contains data in digital format. As an enhancement to the current practice of stamping deposit slips, banks, credit card companies or other intermediaries may also choose a stamp that contains static digital data where that digital data contains constant information that can include the name and address of the bank, credit card company or other intermediary, and a digital signature of the bank. The digital stamp preferably also includes information that varies. That variable information preferably includes a digital signature that includes the time and date of deposit, the name and address of the bank, credit card company or other intermediary, the amount of deposit (i.e., as verified by the bank, credit card company or other intermediary), as well as all of the accumulated digital information included in the deposit slip or bill payment instrument or instruments. In other embodiments, lesser information is included in the digital receipt, such as the time and date of deposit, the name and address of the bank, credit card company or other intermediary, the amount of deposit (i.e., as verified by the bank, credit card company or other intermediary), but not the accumulated digital information from the deposit slip or bill payment instrument or instruments. The digital signature of the bank, credit card company or other intermediary serves as strong evidence that the bank did accept a deposit and the details of that deposit The greater the details included in that digital signature, the greater the details that the bank, credit card company or other intermediary acknowledges. Of course, if any of the digital data is encrypted such that the bank, credit card company or other intermediary cannot read the data, then the digital signature indicates only that the information was received, not read.

The bank, credit card company or other intermediary may choose to acknowledge receipt of the deposit or bill payment instrument or instruments only as part of periodic statements sent to the payee. This acknowledgment can be human readable, digital, or preferably, both.

The bank, credit card company or other intermediary may choose to issue no receipt at all.

In step 119, the bank, credit card company or other intermediary issues a receipt in accordance with the method chosen in step 118.

In step 120, the bank, credit card company or other intermediary selects a method of processing the bill payment instruments. This choice allows the bank, credit card company or other intermediary to choose the degree to which paper bill payment instruments continue to be used. One choice is the use of paper, largely consistent with the traditional method of processing checks. Unlike current practices, however, the paper instruments can contain digital data. Another choice is to process the instruments in electronic form. This involves either receiving the bill payment instruments in electronic form or to convert them into electronic form by scanning the paper instruments first. If the paper instruments contain digital data in machine readable code, the code can then be decoded to put the digital data into electronic form. The image of the paper document, or the digital data contained in the paper document can then be used for further processing. A further possibility is to process the instruments in electronic form and adding a digital signature to the digital information. This digital signature signifies that the bank, credit card company or other intermediary has sent the bill payment instruments along for further processing.

In step 121, the bank, credit card company or other intermediary selects a method for settling payments between the bill presenter and the bill payer. The bank, credit card company or other intermediary receiving the payment instrument may choose to settle directly with the bill presenter and bill payer, or with the bank, credit card company or other intermediary representing the other party, or with a clearing house that acts as a further intermediary. A bank might choose to use the Federal Reserve, the Automated Clearing House, or a debit card network.

A credit card company might choose actual payment or a direct credit. While the invention makes both choices available as a theoretical matter, contractual terms may limit the actual choice made. Consistent with the paradigm of bill payment suggested by the present invention, actual payment can take any of the forms outlined herein, with the bill presenter once again taking the role of the bill presenter and the credit card company or other intermediary taking the role of the bill payer.

Use of direct credits—i.e., making payment by debiting one account and crediting another account—becomes a more likely possibility where certain intermediaries are payment recipients. For example, the United States Postal Service could act as an intermediary where the accounts maintained consist of or are piggybacked onto the postal meter accounts maintained with the Postal Service. Present Postal Service plans call for adoption of a new paradigm for indicia indicating that postage has been paid. The plans call for meters that print postal indicia that includes digital information in a high density code. The same process that transfers value from a postal meter account to an envelope in order to pay postage could be used to transfer value for the payment of a bill instead of postage. The bill payer could print a postal meter indicia on paper (including on the envelope or post card itself, either as part of or separate from the indicia indicating postage paid) that transfers value from the bill payer's postal meter account by reducing that account balance. The payee would upon receipt scan and decode that indicia in order to increase the payee's postal meter account. The payee could alternatively cash or deposit the indicia much like a money order. Such a paradigm would require approval of the Postal Service and would preferably include mechanisms to prevent using the same payment indicia multiple times to get the value multiple times. The techniques described in the context of digital certified checks, as well as known anti-counterfeiting techniques can be used to prevent duplicate copies of the same indicia. Another mechanism involves a process where the payment indicia restricts an increase in a postal meter account to only one specified postal meter and that postal meter's tamperproof postal security device (“PSD”) includes means for storing all increases in the account and preventing a duplicate increase.

In step 122, the bank, credit card company or other intermediary chooses a method for returning the bill payment instruments to the bill payer. The theoretical choices available are the same as discussed in step 108, where the bill payer selects the method preferred for receiving back the bill payment instruments. As also discussed previously, the method is ultimately a contractual matter. If a conflict arises, notwithstanding a contractual agreement, the preferred embodiment resolves any conflict by reference to the choice made by the bank, credit card company or other intermediary because the bank, credit card company or other intermediary has possession of the instruments and therefore controls disposition. Any choice made by the bank, credit card company or other intermediary would of course have to be consistent with any prior processes. For example, if the bill payment instrument was printed by the bill payer as a combination of human readable and digital information and the physical instrument was then sent to the bill presenter which imaged only the digital data for further processing while retaining the physical instrument, the bank, credit card company or other intermediary can return paper instruments to the bill payer, but those paper instruments can only be, in effect, replicas of the original.

In step 123, the bank processes the bill payment instruments, settles the payments, and returns the bill payment instruments. These actions are done in accordance with the selections made in steps 120, 121 and 122. The exact methodology for performing these actions, other than as otherwise described, is consistent with current practices and known to those in the field of banking and finance.

FIG. 2 illustrates a bill produced by the invention which contains both human readable and machine readable information. This bill represents an image that can be printed on paper or transmitted by facsimile or other electronic means.

The statement part 201 of the bill contains both human readable information 202, as well as machine readable information 203. The human readable information 202 contains the information necessary for the bill payer to determine the appropriateness of the bill. Machine readable information 203 contains in digital form information about the bill. Machine readable information 203 on the statement part 201 of the bill is primarily intended for the purpose of allowing the bill payer to import bill information into the bill payer's computer. This information, discussed more fully by reference to FIG. 1, preferably includes at a minimum, all of the information printed on the bill.

If a sufficiently high density code is used, the information can be not only about the current period or transaction, but also an accumulation of data from prior periods. Credit card companies, for example, could include at the end of each year (or at the beginning of the following year) all transactions of the prior year. This inclusion could prove a great benefit to the bill payer for purposes of tracking personal finances and/or tax return preparation. By having all transactions in electronic form, the bill payer can manipulate the data, perhaps by clicking and dragging each separate transaction to an appropriate category of expense or deduction.

The bill also contains bill payment stub 204 In those instances where the bill is printed on paper, either by the bill presenter or, following facsimile or other electronic transmission, the bill payer, bill payment stub 204 is physically separated from the statement part 201 at perforation line 205. In those instances where the bill presenter prints the bill, the perforation line 205 preferably represents an actual perforation of the paper so as to aid the bill payer in separating bill payment stub 204 from the statement part 201 of the bill.

Bill payment stub 204 contains human readable information 206 and machine readable code 207. The human readable information 206 is intended primarily to assist the bill presenter when the bill payment is sent back to the bill presenter together with bill payment stub 204. The information in human readable form preferably includes that minimum needed by the bill presenter to process the bill payment received. The machine readable code 207 is intended to be the digital information which is used by the invention for all further purposes as described by reference to FIG. 1 including preparation and transmission of bill payment instruments by computer or other electronic device, deposit of bill payment instruments and processing of bill payment instruments by banks, credit card companies or other intermediaries. Machine readable information 203 in the statement part 201 of the bill could be identical to machine readable code 207 in bill payment stub 204. In the preferred embodiment, redundancy is provided so that the bill payer is left with the digital data even after bill payment stub 204 is sent to the bill presenter.

The bill illustrated in FIG. 2 is intended to be consistent with current practices for bills other than the inclusion of digital data in machine readable information 203 and machine readable code 207. For example, the human readable information 202 in statement part 201 and human readable information 206 in bill payment stub 204 could contain addresses placed in locations such that those addresses can show through clear windows in envelopes that contain the bills or bill payment stubs 204.

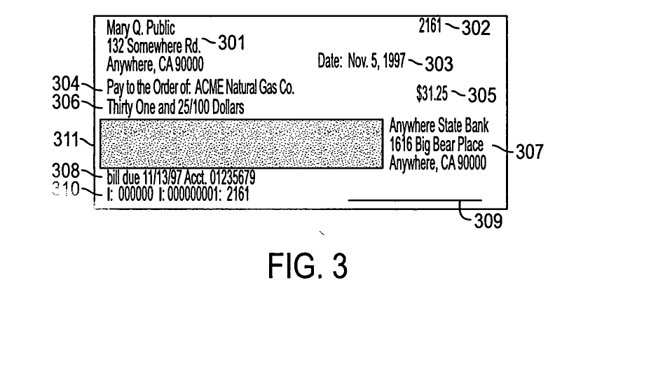

FIG. 3 illustrates a bill payment instrument containing bill payment information in digital form. This bill payment instrument represents an image that can be printed on paper or transmitted by facsimile or other electronic means.

The bill payment instrument illustrated contains the same information that traditional checks contain. The bill payment instrument contains payer name and address 301, bill payment instrument number 302, date of issue 303, indication of payee 304, courtesy amount of payment 305, legal amount of payment 306, name and address of paying bank 307, memo 308, signature line 309, magnetic ink instrument information 310. The bill payment instrument also contains machine readable code 311.

While the bill payment instrument illustrated contains the same information contained in traditional checks, any of this traditional information can be omitted, replaced by information contained in the machine readable code 311. In particular, while the instrument has a signature line 309, a manual signature or replica thereof is just one possibility for signing the instrument. Furthermore, the preferred embodiment omits magnetic ink instrument information 310.

Machine readable code 311 preferably includes the digital information made available in a digital form by a bill an example of which is illustrated in FIG. 2, as well as digital information represented by the bill payment itself The information that is included is described by reference to FIG. 1. This information might include, for example, a digital signature of the bill payer. The machine readable code is preferably a high density code.

### Audit Trail Paradigm Based on Digital Signatures

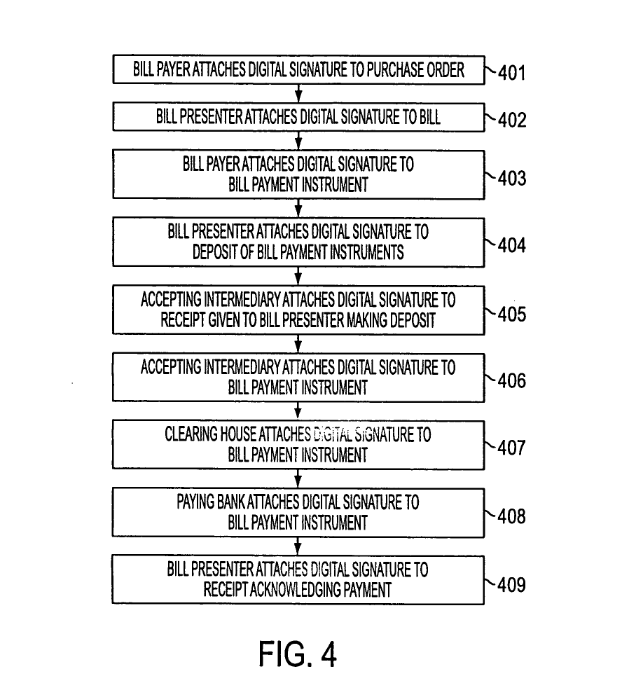

FIG. 4 is a block diagram illustrating the digital signatures applied to create a new paradigm for an audit trail. This audit trail exists by virtue of establishing proof of what each party has done at each step of the process. Assuming appropriate protocols are followed, the paradigm produces a high degree of confidence of what each party has done while allowing the bill presentment and payment process,proceed through digital instruments. The digital signatures applied are assumed to contain the information contained in the instrument to which the digital signature is applied. It should be understood that while the process illustrated through FIG. 4 represents the preferred embodiment of the digital audit trail, other embodiments contain only some of the steps so described, or further steps not described, and offer varying degrees of proof of actions taken. In still other embodiments, the digital signatures do not contain the information contained in the instrument to which the digital signature is applied. The digital signatures in these embodiments provide some evidence of actions taken.

The process starts in step 401 when the bill payer (i.e., the purchaser) produces a purchase order. In some embodiments, the purchase order itself is produced by a series of digital signatures where each of several persons within the purchasing organization signifies their approval of the purchase requisition by attaching their digital signature. In yet other embodiments, there is no purchase order or a digital signature is not attached. For example, a purchaser may telephone an order to the bill presenter or the case of many consumer bills, the purchase may be automatic, as in the case of utility services. The digital signature in step 401 establishes proof that the purchaser did indeed prepare and send the purchase order, including all details included in that purchase order.

In step 402, the bill presenter attaches the bill presenter's digital signature to the bill. That digital signature preferably contains the relevant details of the bill in order to serve as proof that the bill presenter did indeed present that bill. The level of confidence can be as high or higher than a printed bill in human readable even if the bill with the digital signature arrives in purely digital form.

In step 403, the bill payer attaches the bill payer's digital signature to the bill payment instrument. This digital signature preferably includes all of the information accumulated to this point in the process preferably including the data included in the purchase order in its digital signature, the bill's digital data in its digital signature, and the additional data that make the bill payment instrument. The bill payment instrument's digital signature, along with any other signature, provides proof of the intention to make payment and the reasons therefor.

In step 404, assuming the bill payer sends the bill payment instrument to the bill presenter, the bill presenter attaches its digital signature to the bill payment instrument as part of its deposit or other presentment of the bill payment instrument for payment. This digital signature preferably includes all previous digital data included to that point in the process. The digital signature could also include identifying information, such as a face picture, fingerprint, palmprint, digital motor control, retina scan, or voiceprint, unique to the person depositing or otherwise presenting the instrument for payment. This digital signature provides proof that the bill presenter did in fact deposit, cash or otherwise present the instrument for payment and that that person knew (or should have known) the reasons for the payment.

In step 405, in instances where a receipt is given for a deposit or other presentment for payment, the bank, credit card company or other intermediary issues that receipt with a digital signature. As is the case for prior steps, this digital signature preferably includes all the digital data accumulated to that point of the process, including the digital data of each instrument included in the deposit. This digital signature signifies that the bank, credit card company or other intermediary received the deposit and would therefore have great difficulty in later refuting that fact.

In step 406, the bank, credit card company or other intermediary attaches its digital signature to the bill payment instrument as that instrument is prepared for further processing. As the instrument is passed along for this further processing, the digital signature indicates that the bank, credit card company did receive the instrument and intended to further process that bill payment instrument. While the bank, credit card company or other intermediary may have already attached its digital signature to a deposit receipt in step 405, that digital signature will not continue on in the instrument clearing process while the digital signature in step 406 does continue in the process.

In those instances where the bill payment instrument is processed through a clearing house, in step 407 the clearing house preferably attaches its digital signature to each bill payment instrument, signifying that it has received and is processing the bill payment instrument.

When the bank, credit card company or other intermediary representing the bill payer pays on the bill instrument, in step 408, it attaches its digital signature to the instrument, including the accumulation of digital data to that point. This digital signature signifies that it has received the instrument and intended to pay the funds to the bill presenter, deducting the funds from the account of the bill payer, together with all of the reasons for the payment.

While current practices do not commonly require the bill presenter to provide a receipt when it is paid or credited with the funds, in step 409, the bill presenter does provide a receipt together with a digital signature that includes the accumulation of data throughout the process. This digital receipt provides very useful proof that the bill presenter has received the funds and the reasons therefor. Barring some discrepancy or mistake introduced at some point in the process, this digital signature closes the cycle, bringing an end to the transaction. The bill payer, or any other party to the transaction, can point to this receipt as proof that the transaction has been completed.

### Other Embodiments

While the preferred embodiment is described by reference to actions of both the bill presenter and the bill payer, further embodiments involve payments by the payer for amounts not billed by a bill presenter. In some such embodiments the bill payer does not owe any amount until the bill payer initiates actions establishing liability, while in other embodiments the bill payer in essence prepares the bill for liability owed.

There are circumstances where no liability is owed until the payer initiates an action. Examples include ordering of goods and contributions to charities. The liability can occur at the same time as the payment, thus precluding the need for a bill. In these embodiments, the parties follow the steps described in FIG. 1 above, starting with step 106, where the payer selects a method to prepare the bill payment. Steps 101 through 105, representing actions by the bill presenter, are not required.

While the bill preparer does not have a bill per se from which to proceed, some embodiments provide information largely comparable to that provided by bills. If, for example, the payer orders goods from a catalog or product sheet, that marketing material can include sufficient information to prepare the bill, including the goods ordered, the amount owed for the goods, the payee, and the payee's address. The person producing the marketing material may choose to include additional information such as information unique to the bill payer (e.g., name, shipping address, account number, checking or credit card number, and preferred method of shipping), information identifying the catalog or other marketing material, sales tax rate based on the shipping address, and acceptable methods of payment. This digital information can then be used to prepare the bill payment instrument as though the digital information came from a bill.

Charitable institutions could likewise choose to include digital information in their solicitations. The institution could choose to include its name, address, reason for the solicitation, and an indication of the institution's tax status. In one such embodiment, the institution could provide a digital signature from the I.R.S. verifying the institution's tax exempt status (e.g., an I.R.S. digital signature that includes the institution's tax-exempt letter ruling). If the institution is soliciting a set dollar amount, the institution could include this information. If a gift is promised in return, the institution could indicate the value of that gift. The payer can use this information to both prepare the bill payment instrument and to prepare the payer's tax return.

### Tax Return Preparation and Processing

In other embodiments, the bill payer prepares the bill for liability owed. A taxpayer's preparation of their tax return represents a prime example of such an embodiment. Liability for income and other taxes clearly exists without the taxpayer receiving a bill. Each taxpayer is legally required to file a tax return which correctly computes the taxpayer's tax liability. The taxpayer may choose (subject to any legal restrictions) to pay this tax bill in accordance with the steps described by reference to FIG. 1 beginning with step 106, where the payer selects a method to prepare the bill payment. The preparation of the “tax bill”—i.e., the tax return—can itself benefit from the inclusion of digital information at various stages of the process.

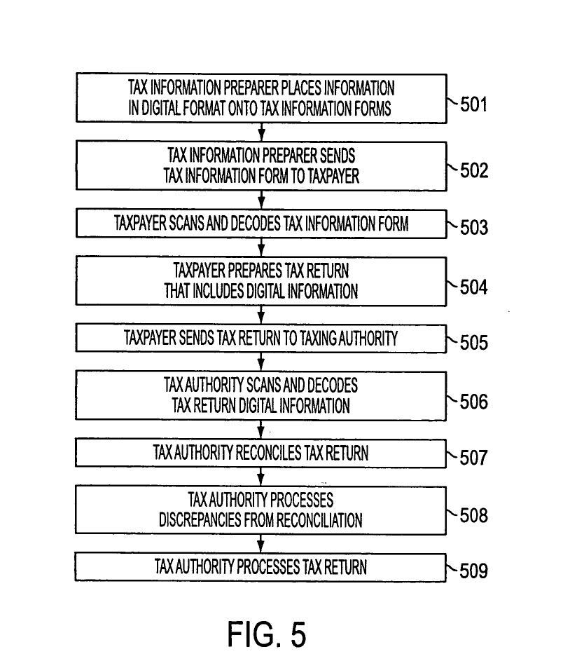

FIG. 5 is a block diagram of a method of tax return preparation and processing that includes digital information at the various stages of the process. In step 501, tax information preparers place information onto tax information forms. The relevant forms in the United States income taxation system include, for example, Forms W-2, 1099, 1098, and K-1, it being understood that any other tax information forms preferably include digital data as well. The forms preferably include information both in human readable and machine readable form. Consistent with current practice, these forms are preferably printed on paper. The information included in both human readable and machine readable form preferably includes at a minimum the names, addresses and taxpayer identification numbers of the preparer and the taxpayer, the monetary (e.g., dollar) amounts being reported, the nature of the amounts being reported, where the nature of the amounts being reported is obvious to those skilled in the field of taxation, and the digital signature of the tax information preparer. The digital signature preferably includes all of the information being reported. This digital signature provides a high level of confidence to the taxing authority that the tax information preparer reported what is claimed to be reported to the taxpayer.

The tax information forms sent to a taxpayer preferably includes a digital form from the taxing authority as part of a package of returns and forms sent to taxpayers where that digital form contains digital data. That digital data preferably includes information that the taxpayer can choose to use to prepare a tax return, including name, address, social security number, dependent information, and filing status. The digital information also preferably includes information reported by the taxpayer in the prior year's return, such as wages, interest income, dividend income, tax and interest deductions, and the parties from which or to which the amounts were received or paid.

In other embodiments, the tax information forms are prepared in electronic form. In some embodiments, the tax information preparer may choose to include (or may by relevant law be required to include) other information. The tax information preparer may choose to include computer instructions directed to the computer of the taxpayer or the taxpayer's tax return preparer that enable that computer to process the information. For example, in the case of a Form 1099-INT, the instructions could instruct the computer running a tax preparation software package to place the Form 1099-INT reported amounts into a computerized worksheet for Schedule B of Form 1040.

In step 502, the tax information preparer sends the tax information forms to the taxpayer. This transmission preferably consists of sending paper forms by the mails. In other embodiments, the transmission is machine code in electronic form, while in still further embodiments, the transmission is human readable information transmitted by fax or by other electronic means.

In step 503, the taxpayer scans and decodes the paper form containing the machine readable information. It should be understood that actions taken by the taxpayer to prepare and process a tax return, other than signing the return, may be done either directly by the taxpayer or delegated to a tax return preparer. The taxpayer preferably signs the return directly—i.e., this action is preferably not delegated. The result of the scanning and decoding is information in electronic format in the taxpayer's or tax return preparer's computer.

In those embodiments where the tax information forms arrive in electronic format, the taxpayer or tax return preparer does not scan the form. Where the form arrives as an image that contains both human readable and machine readable information, the taxpayer's or tax return preparer's computer decodes the machine readable information contained in the image. Where the form arrives in machine code, the information does not require decoding as that term is meant herein.

In step 504, the taxpayer or the tax return preparer prepares the tax return. This preparation is preferably performed by computer. The computer is preferably operating a tax preparation software package, and that tax preparation software preferably allows the computer to place the digital information received in step 503 to be placed, by default, at the location within the software application most likely appropriate for the data, where such location is obvious to those skilled in the field of taxation. The software application preferably allows the taxpayer or tax return preparer to override the default placement and place the information at some other location or to ignore the information altogether. For example, the software package would preferably place data from Form 1099-INT, reporting interest income to an individual, into a computerized worksheet for Schedule B of Form 1040, such that the data is included in Schedule B and eventually Form 1040. The taxpayer or tax return preparer is preferably allowed to override this result in order to place the data, for example, in Schedule C, reporting trade or business income.

Automatic placement of data in default locations in a tax preparation software application allows the taxpayer or tax return preparer to prepare the return without the need for manual input. In some instances, the preparation could be entirely automatic, requiring only scanning of tax information forms by the taxpayer or tax return preparer. In these instances, the computer would prepare the returns based on the information so imported into the software package.

The tax return prepared in step 504 preferably includes the tax return information in both human readable and machine readable form, and is preferably printed on paper. The human readable information consists of the information currently included in tax returns. The machine readable information preferably includes all of the information included on the return as human readable information as well as all of the digital data included in each tax information form that makes up the return. If a payment is due with the return, the digital data preferably includes the payment in digital, as discussed by reference to FIG. 1, with the details of the return representing the bill. The machine readable information also preferably includes the taxpayer's public cryptographic key, the digital signature of the taxpayer and, if the return is prepared by a paid preparer, the paid preparer's digital signature. These digital signatures indicate, with a high level of confidence, that the taxpayer, and the return preparer if any, knew (or should have known) of the information contained in the return. In the preferred embodiment, the machine readable information is printed on a form separate from the human readable information that makes up the normal tax return.

In other embodiments, the tax return contains only human readable information but the taxpayer attaches copies of the tax information forms with the digital data to that tax return. In still further embodiments, the taxpayer produces a printout that includes the machine readable information provided on the tax information forms, and attaches that one printout to the tax return that contains just human readable information.

In step 505, the taxpayer sends the tax return to the taxing authority. In the preferred embodiment, this transmission is performed by sending a paper return through the mails. In other embodiments the transmission is through electronic means. In one such embodiment, the taxpayer sends the return through the tax return preparer, who transmits the tax return to the taxing authority. In another embodiment, the taxpayer feeds the paper return through a fax machine which then transmits the return, including an image of machine readable information that includes the digital data, to a fax server of the taxing authority.

In step 506 of the preferred embodiment, the taxing authority scans and decodes the machine readable code printed on the tax return. The result of this step is that the taxing authority has within its computers the digital data that constitutes the tax return, including all of the data accumulated to that point.

In step 507, the taxing authority reconciles the digital information representing the tax return with the information provided in the digital tax information forms included with the tax return. Where the included tax information forms have been signed with a digital signature of the tax information preparers, there is a high level of confidence that those digital signatures have not been tampered with by the taxpayer or others. If the digital signature includes the information of form itself, there is a high level of confidence that the amounts contained in the digital signature are the amounts reported by the tax information preparers. The taxing authority then automatically compares these digital signatures and the information contained therein with the information provided as part of the return. Discrepancies in amounts or treatments are flagged for further review and processing. If the return includes digital data that includes the digital information from the prior year, items new to or missing from the current return are flagged for further review and processing. Items in the return that do not have corresponding digital signatures can likewise be flagged for further review and processing. Thus, integrating tax data into digital signatures included with the tax return's digital data opens the possibility that tax returns become self-auditing to a large degree.

In step 508, the taxing authority processes the discrepancies flagged in step 507. The manner of processing varies from item to item, with the details obvious to those persons within taxing authorities responsible for setting auditing policies. The invention allows a taxing authority to flag the discrepancies, but it is the taxing authority that must decide what to do with these flagged discrepancies. Algorithms and processes largely known only to taxing authorities currently operate to determine when to audit a taxpayer, when to send an automatic adjustment, and when to ignore certain information. By providing a high level of confidence to a great deal of the information provided in tax returns, this method of tax return preparation and processing provides the great advantage of narrowing the scope of what the taxing authority reasonably devotes its resources to consider.

In step 509, the taxing authority processes the digital information. This step includes the processing traditionally applied to tax return data as well as further processing made possible by the invention.

In those instances where a balance is due the taxing authority and provided in digital form within the machine readable data provided with the return (either as part of the digital data that includes the tax return or as a separate bill payment instrument), the taxing authority processes the bill payment consistent with the description provided by reference to FIG. 1. The endorsement method selected in step 115 preferably includes the digital signature of the taxing authority that includes the details of the tax return itself. Where the taxpayer includes the taxpayer's public cryptographic key in step 504, the tax return data is preferably encrypted so as to keep that information private except as to the taxpayer and the taxing authority.

In those instances where the taxpayer is due a refund, the refund can take the form of any of the possibilities outlined by reference to FIG. 1 for bill payments. The payment preferably includes a digital signature of the taxing authority that includes the details of the tax return on which the refund is based. Where the taxpayer includes the taxpayer's public cryptographic key in step 504, the tax return data is preferably encrypted so as to keep that information private except as to the taxpayer and the taxing authority.

In those instances where payment is due and no refund owed, the preferred embodiment requires the taxing authority to send an acknowledgment of having received the return where that receipt includes a digital signature containing the details of the return.

By providing a digital signature to the taxpayer, the taxing authority is signifying that it has received the return, including any details contained therein, and any accompanying payment and acknowledges being made aware of the reasons given by the taxpayer for any payment made or refund owed. The taxing authority's digital signature is not intended as an acknowledgment of the correctness of the return by the taxing authority.

### Digital Certified Checks, Money Orders and Other Instruments

In certain circumstances, the use of certified checks may be desired by the bill payer or bill presenter. Banks, credit card companies or other intermediaries may choose to certify digital bill payment instruments of the current invention (i.e., bill payment instruments that contain the essential bill payment information in digital format) by attaching the digital signature of the bank, credit card company or other intermediary to the bill payment instrument prior to the bill payer sending the instrument. The attachment is preferably performed by creating a digital signature that includes all of the other information of the bill payment instrument, including the digital data of the bill, plus indication of the date, payee and amount approved by the bank, credit card company or other intermediary, and an indication that the payment is certified. Obviously, the bank, credit card company or other intermediary would certify in this fashion only if it so desired—e.g., if sufficient funds existed.

There may be circumstances where a bill payment instrument can be duplicated or otherwise counterfeited. Certified checks of the current banking system can be counterfeited by replicating the physical markings and alterations currently applied to certified checks. Money orders, currently issued without knowing the payee, can be counterfeited by duplicating the physical instrument.

Further embodiments of the current invention circumvent the potential of counterfeiting physical instruments. The premise underlying these embodiments is that markings on paper can be scanned with much greater resolution than those markings can be printed using ordinary printing processes. For example, while most laser printers top out at a resolution of 600 dpi, current scanners can exceed 10,000 dpi. While the resolution of a scanning process can be easily increased through optics that magnify an image before that image hits the CCD or other light sensor, increasing the resolution of a printing process proves much more difficult. In theory, the resolutions of scanners can be greatly increased through magnifying the image before At a sufficiently high magnification, the placement of ink on paper appears to be a largely random grouping of ink particles around a theoretical center. The anticounterfeiting method of the invention takes advantage of this randomness.

In one such embodiment, 10 ink spots are printed on a paper instrument which does not yet contain the specific payment information in digital form. An ink spot should be understood to mean the smallest placement of ink within the control of the particular printing process. In the case of a 300 dpi laser printer, for example, the printing process can control the placement of ink at every 1/300 inch. An ink spot is the accumulation of ink particles placed by addressing each such 1/300 by 1/300 inch, bearing in mind that many of those ink particles fall outside the 1/300 by 1/300 inch space being addressed. These 10 ink spots are printed at the finest resolution allowed by the printing process, and are printed in close proximity to each other, but not so close that the particles of ink of one spot largely overlap the particles of ink of another ink spot. This spacing is accomplished by placing the center of each of the ink spots at a distance of 3 times the next closest ink spots. In the case of a 600 dpi laser, for example, each of the 10 ink spots are placed 1/100 inch from each other.

Using a scanner of much higher precision, each of the ink spots is then scanned. These ink spots are preferably scanned at a resolution 20 times that of the printing process. The space scanned for each spot is preferably 3 times (in both horizontal and vertical directions) the printing process resolution. In the case of a 300 dpi laser printer, for example, the scanning resolution would preferably be at least 6,000 dpi and the space scanned around the theoretical center of each spot is preferably 1/100 by 1/100 inch. In the case of binary printing, the scanning is preferably grayscale. The result of this scan is a 60 by 60 pixel grayscale image. For each of the 3,600 scan pixels, the method described in the pending Antognini et al. U.S. patent application that was filed Mar. 1, 1996, under Ser. No. 08/609,549 on “Variable Formatting of Digital Data Into a Pattern”, for determining whether a scanner pixel is turned on or off is used to determine the presence or absence of ink particles in scanner pixels in the present embodiment. The results of this process (i.e., a digital database of 10 images each consisting of 3,600 determinations of whether an ink particle is present) are then placed in a machine readable code and printed on the instrument.

Standard template pattern matching algorithms, known to those in the art, can be employed to determine whether there is a match between the digital database of determinations printed in the machine readable code on the paper instrument and a digital database of determinations produced by scanning the 10 ink spots a second time, where the second scan is done to determine counterfeiting.

When a bill payer wants to prepare a bill payment instrument on this counterfeit-proof paper, the bill payer scans the machine readable code on that paper, and then transmits the results to the bank, credit card company or other intermediary, together with the details of the payment, as discussed above. The bank, credit card company or other intermediary then creates a digital signature that contains the details of the bill payment, as discussed above, plus the digital database of image determinations. The bank, credit card company or other intermediary then transmits its digital signature to the bill payer. The bill payer prints that digital signature on the paper instrument.

The likelihood of another printed instrument printed with the same process containing ink particles located at the same locations are astronomical. The odds can be reduced to the extent that paper can be printed with a more precise printing process. The bill payer, or the bank, credit card company or other intermediary must decide the degree of certainty it wants that another paper instrument can contain the same dispersement of ink particles.

If the bank, credit card company or other intermediary has a high level of confidence that another paper instrument with the same dispersion of ink particles cannot reasonably be produced, then there is a high level of confidence that that paper instrument, and only that paper instrument contains the payment certified by the bank, credit card company or other intermediary.

While the anti-counterfeiting method is described in the context of a bill payment instrument, the method has equal applicability in other embodiments. The method can be applied to currency, artwork, stock certificates, other certificates, diplomas, bonds, notes, contracts, tickets, paper that contains machine readable information of other digital data (e.g., machine readable information that contains a sound recording or a software application), or any other paper that should not be duplicated, whether or not that paper contains digital data other than the digital data for anti-counterfeiting purposes.

In still further embodiments, the digital database of image determinations is not printed on the paper but is instead stored in some other media. The presence of ink spots on the paper still signifies a unique piece of paper which can be verified by referencing the digital database from such other media.

### Color Printing of Machine Readable Code

In the preferred embodiment, printing of machine readable code on paper is accomplished through binary printing. In other embodiments, the printing is accomplished through color printing.

In one such embodiment, the color printing allows the placement of multiple machine readable symbols in the same space. In one such embodiment the placement of multiple symbols is accomplished by placing spots (where the digital data value of a cell requires a spot) of one color adjacent or nearly adjacent to spots of different colors so that spots (regardless of color) do not substantially overlap each other. In another embodiment, the symbols are placed on top of each other regardless of whether they overlap.

In another such embodiment, machine readable code of one color, and human readable information (e.g., text or graphics) are printed in the same space. In one such embodiment, human readable information is printed on paper first using cyan color ink while machine readable information is printed using yellow ink—the yellow ink is largely unnoticeable to the human eye but it can be discerned by a color scanner. The cyan ink is clearly discernible to the human eye, notwithstanding the presence of the yellow ink.

### Paper Based User Interface to Process Transactions

It is today universally acknowledged that the graphical user interface (GUI) was a fundamental improvement over the command line interface of the first computers. Yet the paradigm of the GUI has by now largely exhausted its potential to make interaction with a computer easier and more effective for most people. Evidence of this is that first time PC buyers have become a small and diminishing fraction of the PC market. The market for the GUI appears to have reached a ceiling.

Barcodes can help solve the most fundamental problem facing the acceptance of digital devices in general, and electronic commerce in particular: the large number of application interfaces a consumer must grasp, and feel comfortable with, to use these technologies effectively. Even those who succeed in mastering a few such interfaces do not often achieve fluency in them all, since the number of them is typically too great.

As a technology, bar codes also enable considerable ease-of-use. Once a user has learned to scan with the bar code reader, he or she often needs to know nothing else. The content of the bar code itself will direct the further actions of the device to which the bar code reader is attached. This intuitive notion grounds a new approach to user interface embodied in the present invention.

The basic concept is that paper can itself function as user interface. On a sheet of paper, one can encode a pattern of machine readable information (“pattern”) that automatically invokes certain functions when scanned. The paper would include a description of the actions that would ensue if the pattern was scanned. The patterns become in effect paper-based “icons.” Just as the notion of icons has proved remarkably fruitful in standard GUls, so will they also if embedded in documents.

One class of GUI icon may serve as a familiar model for what paper-based icons can do. These icons support the automatic registration of software. When clicked upon, they initialize the modem, call up an 800 number, and transmit registration information.

Encoded patterns on paper can indeed be more powerful than such GUI icons—and herein lies much of the force of the new approach. GUI icons are virtually always generic in that they apply uniformly to any user who would invoke them. Information peculiar to the individual, and required for an action, must be obtained by other means. For example, when registering software, one is obliged first to enter by hand a fair amount of personal data: name, address, phone number, company name, title, etc.

In contrast, patterns on a paper bill, for example, could contain individualized information—name, address, account number, keys, current outstanding amount, minimum payment, etc. It might also contain information peculiar to the transaction implicit in the bill—an on-line dial up number, the kind of transaction expected, the type of account. Banking software, or a bank statement, or a smart card, might independently store on the consumer's PC relevant bank account information. Thus, a simple scan of the bill—an act so intuitive any consumer could understand it—could, in principle, pay the bill. It might invoke the banking software, combine the information for the bank account and the payment transaction, call up the on-line number, and transmit account number, payment amount, bank account, digital authentication, etc. (Alternatively, the software might call up the bank, and the conduct the transaction via that route.) If it is felt that the transaction is too easy, so that an inadvertent scan would pay a bill when not really intended, there are simple remedies. A standard screen, detailing the effect of the transaction, can create a pause before the transaction is consummated. Some quite deliberate action—shift-X for example—might be required before consent is assumed.

Such a scenario depicts a transaction inherently easier, and more comfortable, for most consumers than any purely electronic alternative. The user will have been spared all possible keystrokes and point-clicks. The user would not be required to perform navigation, or data entry, to indicate the particular thing he or she wishes to have done. All such detail is implicit in, for example, the bill in the user's hand, and the encoded pattern makes it explicit to the digital device. An exclusively electronic transaction, in contrast, demands that the particular intention be communicated manually to the computer. It is for this reason that the standard GUI requires an array of interfaces, one each for each application. This additional complexity deters most consumers from making use of purely electronic transactions altogether.

Similarly, statements, forms, and other standard consumer correspondence could be encoded to capture desired and relevant actions. The locus of the decision to proceed is entirely situated in the comfortable realm of paper, rather than on the computer

When transactions are invoked via a paper document, it is often possible to encode in that document all the relevant information for the transaction to be conducted. This for example might typically be the case for retrieving up-to-the-minute account information, when one has in hand an appropriately encoded credit card statement. For many transactions, however, more information may be required. For example, it may be that to pay a bill, the relevant bank account is not known in advance by the biller. In that case, the bank account information must be provided in other ways. One possibility is to have it supplied as a default in the banking software loaded on one's personal computer. While this can work for many important cases, it will restrict the use of the technique to computers or information appliances on which the particular software has been loaded in advance.

Another possibility is to have it encoded in a smart card. This too requires that the relevant information be loaded on the smart card.

Still another possibility is to have the information encoded in a pattern on a paper document from the bank, perhaps a statement from the bank about that very account. The software could selectively pull out the relevant information from such a pattern, which might have a good deal of other information included as well. The user would simply be asked after the bill is entered to provide the information by inserting the relevant smart card or document from the bank.

Combining the input of several encoded documents (and perhaps smart cards) represents a powerful general technique for conducting transactions, and/or filling out forms, which generally require the same sort of information again and again—names, addresses, phone numbers, account numbers, etc. Much of this could be provided by inserting one or very few relevant encoded documents into a scanner after the transaction itself has been identified via the insertion of a form, bill, invoice, correspondence, etc. (A mortgage application might for example require that documents with identifying information for both spouses be scanned in.) This again minimizes the amount of input the user must provide in order to enable the transaction to occur. This approach possesses important practical virtues. It embodies great ease-of-use, eliminating much of the tedium and/or confusion inherent in filling out purely monitor-and-keyboard based transactions or forms. It also is directed and focused in its use, because it is driven by a known transaction based on a known paper document. These features will facilitate the use of computer based technologies, rather than the purely paper based approaches most people employ and feel comfortable with today.

In order to facilitate this technique, it will be necessary to establish standard fields for entry into transactions and forms—e.g., Name, title, physical address, voice phone number, fax phone number, e-mail address at work and personal, various kinds of account numbers including credit, debit, or other card numbers.

This technique is generally preferable to voice processing, Intelligent Character Recognition (ICR), and key entry, because it should almost always be perfectly accurate: it enters digital information that has presumably already been verified. The technique may not, however, in some cases be able to input all the fields that must be filled in order to complete the transaction of form. In those cases, it may be necessary to fill the remaining fields by means of voice processing, ICR, and/or key entry.

A single pattern on a page might invoke just one transaction, such as bill payment. In this case, that action might be executed without further input from the user, or it might require a keystroke or set of keystrokes (including perhaps a PIN number), depending on which the user feels most comfortable with, as indicating assent. Another possibility however is for a single pattern to encode a number of relevant transactions. After scanning in the pattern, the choices might be described visually on an attached display, along with a indication of which button should be pushed to select each choice. Likewise, these choices might be described by voice (using perhaps speech synthesis) much like ordinary voice menus on touch tone telephones. The descriptions of the choices, the buttons related to them, and the relevant information to conduct the transaction could all be encoded in a pattern.

The value of encoding more than one transaction (or task) in a single pattern is that, first, it can make the scanning process easier to perform. In some cases, one might wish to perform more than one transaction, and it is more convenient to scan one pattern than a number of them, one for each transaction. Second, it permits the some or all of the choices to be described only in the display, and not on the sheet of paper, which may in some circumstances be more appropriate. Third, it presents less visual clutter on the page, and constrains less the layout of the page.

Example transactions that can be so conducted are bill payment, ordering an item from a paper catalog or paper-based advertisement, requesting more information about such items, and displaying up-to-the-minute account information from a creditor, ordering a magazine subscription based on an insert in a printed publication, ordering fast food or other consumer item from a printed form, applying for a credit card or credit line, applying for a mortgage, car loan, or other loan.

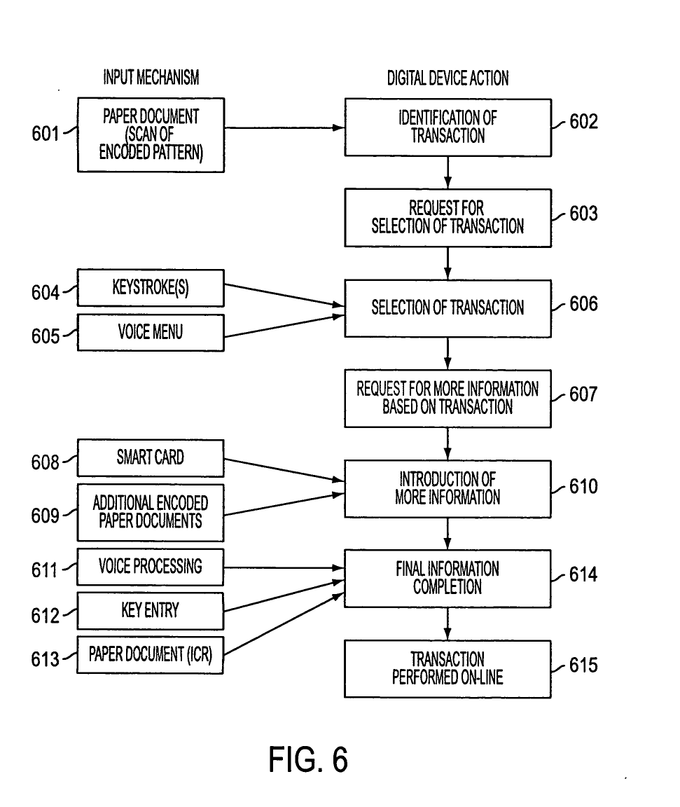

In FIG. 6 (High level flowchart of paper-based transaction system), the steps representing the nature of the processing of the invention are depicted in a high level flowchart. The flowchart is divided into two portions, the mechanisms whereby input is introduced to the digital device on the left, and the action of the digital device on the right. The first box on the left, 601, represents the encoded paper document, which is introduced in a digitized form into the digital device by means of a scan, or an image capture. The first box on the right, 602, represents the decoding of the pattern on the paper document, and the identification of the transaction, or transactions, that the document is enabling. The nature of those transactions will typically be described in text on the document itself, but may not always be so described. At this point, the set of transactions will be described to the user via a text or graphical display, or via a voice description (box 603). The user will respond by selecting a transaction either by voice, or by keystrokes, or perhaps by touching a touchscreen. Boxes 604, and 605 represent these two modalities or response, and box 606 represents the digital device's internal selection of transaction based on the input. Based on the transaction selected, the information the digital device knows it has, and the information it knows it needs to have to conduct the selected transaction, the device may request from the user, via display or voice, further information needed to conduct the transaction. This is represented by box 607. The request for further information will typically involve two aspects, the first of which will typically introduce as much digitally perfect information as possible, the second of which may involve more uncertain, or more tediously entered, information. The nature of the first type of request will typically be for some other encoded paper documents or smart cards to fulfill some or all of the remaining fields. At this time, the user may respond by inserting a smart card(s) (box 608) and/or scanning appropriate encoded paper documents (box 609). This information is placed by the digital device into the appropriate fields for the transaction (box 610). Not all fields may be fulfillable by these means, however, and further inquiries may have to be made of the user to prepare the transaction. This represents the second type of request that the device may make of the user for information. The digital device may request the final required information via either voice or display, and that information may be supplied via voice processing, or key or touchscreen entry (boxes 611 and 612). In some cases, all or some of the information may also be obtained by Intelligent Character Recognition (input represented by box 613) on one or a number of the scanned paper documents. When the information is completed as required by the transaction (box 614), it may then be consummated in the appropriate fashion, typically by communicating the organized information on-line (box 615).

A further functionality would be to encode a fax number or e-mail address on a paper document, so that when the document is scanned, the fax number or e-mail address is recovered via the decoding process, and the scanned image itself is automatically faxed or sent by e-mail without any data entry or user manipulation of the fax machine or multi-function peripheral (MFP) or scanner. This allows any consumer to use the device, because no training is required to launch the fax or e-mail. The paper document might be a form that is filled out by hand by the consumer, and faxed or e-mailed to the organization that produced the form. Different fax or e-mail addresses might be used depending on which form it is, thereby allowing distinct kinds of processing or archiving to occur at the receiving end.

The form might also be processed first at the consumer's end (i.e., the sender's end), using Intelligent Character Recognition (ICR) techniques, to recover the information that has been entered. The ICR process can be guided by format parameters encoded in the pattern, detailing what sort of information is expected at various places on the form. This information might include, for example, where checkboxes are, where numeric information or textual information is expected, what the legitimate set of values is for the various fields. When the ICR techniques fail to recover a result with great confidence, the sender can be asked on the computer screen to settle which interpretation is correct. The important virtue of this approach is that the errors are corrected at the source by the party who knows the correct answer, and is done at the sending end rather than the receiving end, sparing the organization receiving the forms the burden of processing a large volume of paper documents. In addition, the sending party can be queried about information that was either not entered, or was entered incorrectly or inadequately. A user may in fact choose, and be allowed, to leave all items blank, preferring to enter all the information by voice or via the queries. These queries can be conducted via a monitor and possibly restricted keyboard, or touchscreen, or they can be conducted in part via voice recognition. The content of the queries, the conditions under which they are invoked, and the expected responses, can all be encoded in the pattern placed on the document. The voice responses themselves can be sent as files via e-mail to the recipient, in addition to or instead of possible results of voice recognition at the sending end, allowing human operators or more intensive algorithmic processing at the recipient's end to interpret uncertain responses.

In general, the point of these techniques as a class is to force the paper processing upstream, back to the consumer, who is in the best position to understand what his or her intentions are, rather than present the organization with a paper form which must be processed and interpreted in order to reduce it to the digital content implicit within it.

In some cases, it may be that the ICR or voice processing software relevant to processing a document might be downloaded over the Internet, based on a address and access keys provided in the encoded paper document, rather than having to reside on the computer or digital device physically present to the user.

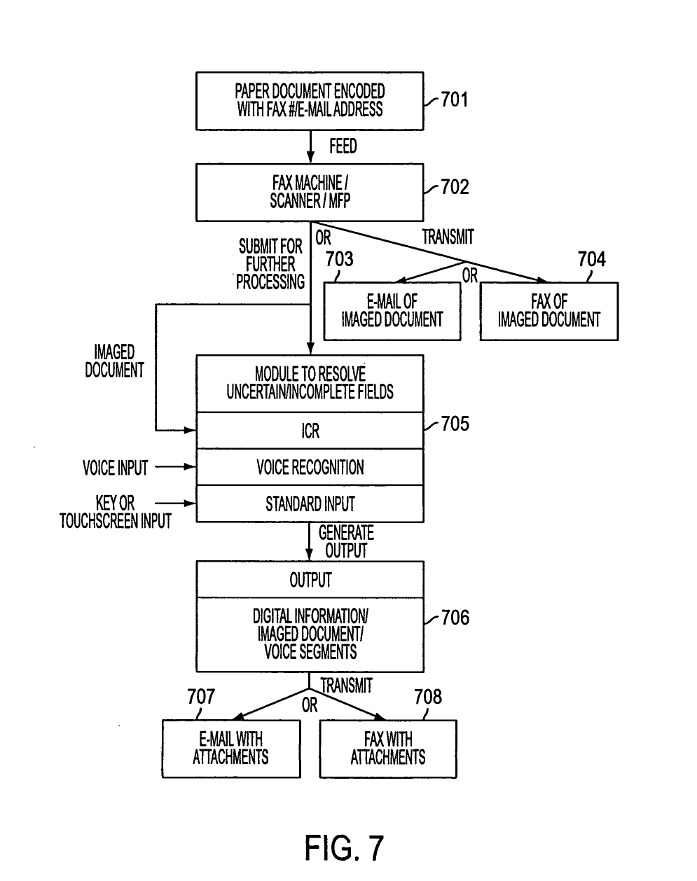

FIG. 7 represents the automation of faxing or e-mailing of an encoded paper document. The first box, 701, represents the paper document encoded with contact information such as e-mail address, public key, and/or a fax number, perhaps a public key, as well as, possibly, descriptors for the various information to be expressed or otherwise captured in the communication which the document will enable. This document is fed into a fax machine, or a scanner, or an Multi-Function Peripheral (MFP) (box 702), which scans the document and decodes the pattern. In the simpler cases, the pattern will encode a fax number and/or an e-mail address, and a flag indicating which functionality may be invoked. The device will choose between the allowed and enabled functionalities, and either send off a fax of the imaged document to the fax number (box 703), or will send an e-mail of the document (typically captured as an attached file to the ASCII e-mail) off to the e-mail address (box 704).

In the more complex cases, the document may be subjected to further processing to extract further information before the communication is consummated. In this case, the image of the document, and the decoded information from the pattern will be forwarded to another set of modules, represented by box 705. These modules may typically attempt to pull out further information from the document by means of Intelligent Character Recognition (ICR) and by forms recognition (e.g., determining whether certain checkboxes have been checked.) Some or all of the information may yet be incomplete or uncertain even after this step, and at this point the user may be asked, by display or voice, for further information to prepare the communication. This information may be determined variously by voice recognition or by standard input via key strokes or touchscreen input.

This information is forwarded to the next module, box 706, which assembles the output into a suitable form to be communicated. The output may assume the form of the original scanned document along with the digital information that has been extracted in the previous modules. It may also include voice segments that can be processed by human operators at the recipient's end to decipher voice responses not recognized to a high enough level of certainty on the digital device, or simply not processed at all by the device. These voice segments may also serve as a form of biometric identification. Finally, the assembled message may be sent out either as an e-mail with attachments to the encoded e-mail address (box 707), or as a fax with attachments to the appropriate fax number (box 708). The attachments with the fax may assume the form of a further encoded pattern in the fax image, or it may be a digital file if it is sent to a fax server.

While many consumer devices get cheaper, and far more powerful, it is a general problem that each has a distinctive interface, and a distinctive set of information that needs to be input in order to make it perform the functionalities, and connect to the digital media, of which it is capable.

One solution to this is to make available in one place all of the contact and address information necessary to perform various functions for any number of devices. Thus, on a paper bill or other consumer correspondence, on the back of business card, or on promotional literature, there might be located a printed pattern encoding digital information that includes, phone numbers, fax numbers (including fax back information), keys for encryption, e-mail addresses, web sites, pager numbers, etc. A scanner or digital camera attached to a phone receiver, for example, could scan the pattern, decode it with an embedded chip, and pull out selectively the phone number. If that phone also has web abilities, it might pull out the web address, and access it. This might contain an auditory message, or perhaps a text message that could be translated via speech synthesis. Or it might have a display on which the contents are shown automatically. The ability to extract relevant contact and address and encryption data would be especially important for small handheld devices, since the interface for such devices cannot include such devices as a mouse or a keyboard, which allow more convenient entry of elaborate information, such as URLs, e-mail addresses, and keys used for security.

A fax machine might scan in the same pattern, and similarly pull out the fax number, to which it might send off a fax. A pager might extract the pager number.

For devices that can employ more than one piece of contact information, it may be also that a button could move it from one mode to another, enabling a particular functionality, based on the relevant information in the encoded pattern. Thus, a phone with web access and e-mail capabilities might in one mode place a phone call, in another retrieve information from the web, and in still another send or retrieve e-mail. Each could be invoked by a single button push.

The fact that all of these devices might be enabled by one pattern creates a synergistic reason for including such patterns in a large variety of places, promoting the deployment of the technology. That is, the “critical mass” of functionalities enabled by the pattern plays an important practical role, because a single device or type of device, even if it is as general as a PC in capabilities, may in many circumstances be deemed insufficient to motivate the utilization of the technology in a given context. If virtually any device can be so enabled however, it may be quite compelling to introduce the pattern, since the number of people who might use it, and the number of circumstances in which they might use it, would push it over the threshold in convenience and effectiveness to the target audience for the document.

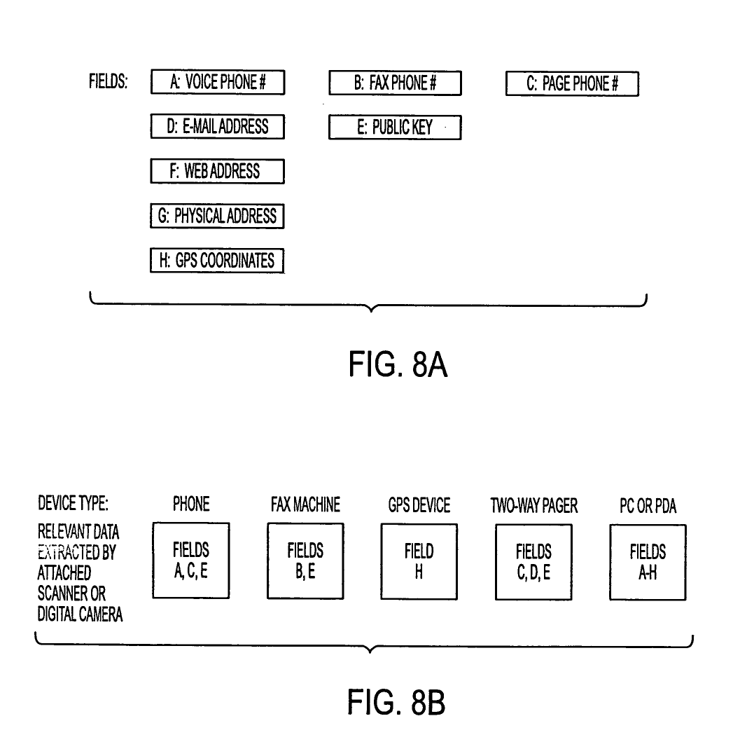

FIGS. 8A and 8B represent an example of how many distinct digital devices may be enabled and supported by the contact information encoded in a single printed pattern.

FIG. 8A shows the data structure carried by such a pattern. This data structure has a wide variety of information, including a voice phone number, a fax phone number, a page phone number, an e-mail address, a public key (perhaps used for encrypting information using any of the enabled devices—voice, e-mail, fax, web site), a web address, a physical address, and Global Positioning System (GPS) coordinates.

FIG. 8B shows example digital devices that might pull out from the data structure of FIG. 8A various sets of fields relevant to the particular functionalities residing in the particular device. Thus, the phone might after scanning the pattern with an attached image capture device and decoding the image, pull out from the data structure just the fields for a voice phone number to be called, and a page phone number, and perhaps a public key to encrypt communication. A fax machine might likewise scan the pattern and pull out the fax phone number and the public key. A GPS device might pull out the GPS coordinates to program a destination. A two-way pager, which can page a number, as well as receive a page, and may include various other forms of communication such as e-mail or voice with that page, might pull in the page phone number, the e-mail address, and the public key. A PC or Personal Digital Assistant (PDA), or like information appliance, might pull in the entire data structure, since each of these might be made fully general in its capabilities, or at least might serve as a convenient mechanism whereby contact information can be collected and stored for later use.

Once the information is imported into the digital devices, they might be automatically linked to the press of a single button on the device, so that e.g., by pressing a single button on a phone, that number is automatically called.

A new type of device is currently being introduced as consumer and office equipment, the multi-functional peripheral (MFP). This device typically permits printing, scanning, digital copying, and faxing. For such a device, and for more restricted devices such as fax machines and digital copiers, encoding digital information on paper can play a powerful role in promoting convenience, ease-of-use, and efficiency in the use of the device, as well as eliminating real or potential sources of waste.

Among the major causes of waste and expense in the use of standard analog copy machine is the problem with paper jams. These jams are very often caused by the feeding mechanism for the original document, since that document is often not in a pristine state when it is inserted into the feeder. Very often, this document may have been handled a great deal, stapled, paper-clipped, in one way or another bound, folded, creased, crumpled, or otherwise been made more liable to jam when fed through an automatic document feeder

The techniques described earlier allow the full contents of a document in digital form to be encoded in a relatively small area, very often a portion of one printed page. By feeding in this one page, and decoding the pattern expressing the document, the entire document can successfully be reprinted. Alternatively, the pattern may also encode an address, and/or means of access for the document. This may be the address on a disk attached to the digital copier or MFP, on the local computer network to which the digital copier or MFP is connected, on the Internet, to which the digital copier or MFP is connected. A still further mechanism would be a dial up number and further access information to retrieve the file via modem, or by means of a fax back. In some cases, if the document is retrieved via an address and/or access mechanism, an updated version of the document may actually be returned and printed. Any number of addresses or mechanisms might also be encoded, and a priority assigned to the preferred order of search for a document. Thus, the local disk might be the first place searched, but if it does not hold the document, then perhaps it is retrieved over the Internet.

Performing “copying” via a digitally encoded pattern also engenders other important efficiencies. It is possible to append the pattern to the final page, for example, and detach only that final page when the copying must be done. This is important in the conduct of meetings, where often there is only one copy of an important document available, and the meeting cannot proceed efficiently if that copy of the document must be removed to make further copies for others in the meeting. Moreover, the copying process itself is far more efficient, since the scan of the pattern can be finished very often in seconds, and the document or the page with the pattern can be removed while the perhaps far more lengthy process of printing takes place.

A further efficiency is that documents need not typically be unbound, and/or unstapled in order to be copied in this manner. The one page (or small number of pages) may be dealt with manually by placing the page or pages on the platen, rather than by preparing it for an automatic document feeder.

In general, one of the difficult things with retrieving information over the Internet is that it requires navigation, and often elaborate mouse or key entry. Many people cannot do this without considerable training in the use of a mouse, a keyboard, and the use of a web browser. Even for those who are trained, it can be a considerable inconvenience, perhaps particularly when usernames and passwords, and/or keys must be employed to access the relevant document. By encoding all of this relevant address and access information into a pattern, the document can be retrieved by a scan. Thus, retrieving information over the Internet becomes a one-button push operation—as simple as copying a page on a standard copier.

By encoding various front panel operations (or operations selected at an attached device, such as a PC) in a printed pattern, an MFP (or digital copier, or fax machine) can also reduce complicated sequence of button entries into a simple scan, a one-button operation. For example, after sending a fax once to a party, with the proper settings, the fax number, settings, etc., can be saved once and for all to paper, so that they never again need be reentered.

The technique of reducing the front panel (or attached device) operations to an encoded pattern is particularly useful since the meaning of the pattern can be understood and used at devices other than the particular one at which it was originally encoded. Among the items that can be so encoded are a fax number, or list of fax numbers to which a fax should be sent; whether fine should be set on; whether pages should be rotated, collated, reduced or enlarged, stapled, bound, how many copies should be generated; e-mail addresses to which the image itself, or some digital document pointed to by an address and access information encoded, should be sent; fonts that can be downloaded; job control information for a page description language such as PostScript or PCL; network addresses to which pages to be scanned should be sent; an encoding of a cover page to be sent along with a fax, or a print or copy job; header, footer, and background templates for a fax, or a print or copy job.

1. A method of bill presentment comprising the steps of:
accessing information concerning the bill,
selecting information to include in the bill where at least one available choice in the selection consists of digital data sufficient to pay the bill, and where at least some of the information selected consists of information accessed,
selecting at least one means for sending the bill,
preparing the bill in accordance with the information selected to be included, and
sending the bill in accordance with the at least one means selected for sending the bill.

2. A method of payment comprising the steps of:
selecting a means for payment where at least one available choice consists of digital data sufficient to pay,
selecting a means for sending the payment,
selecting a person to receive the payment,
preparing a payment in accordance with the means selected for paying, and
sending the bill so prepared consistent with the means selected for sending the bill to the person selected to receive the bill.

3. A bill that contains in digital form sufficient information to pay the bill.

4. A bill payment instrument which contains in digital form sufficient information to pay a bill.
